(19) United States
(12) Patent Application Publication
(10) Pub. No.: US 2011/0307603 A1
(43) Pub. Date: Dec. 15, 2011

(54) BROKER NODE AND EVENT TOPIC CONTROL METHOD IN DISTRIBUTED EVENT DISTRIBUTION SYSTEM

(75) Inventor: Yuichi Ishikawa, Tokyo (JP)

(73) Assignee: NEC Corporation, Tokyo (JP)

(21) Appl. No.: 13/147,675

(22) PCT Filed: Feb. 4, 2010
(86) PCT No.: PCT/JP2010/000684

§ 371 Date: Aug. 24, 2011

(30) Foreign Application Priority Data
Feb. 5, 2009 (JP) 2009-024590

(51) Int. Cl. G06F 13/00; G06F 15/16

(52) U.S. Cl. 709/224

(57) ABSTRACT

A broker node transmits an event in a distributed event distribution system. In order to flexibly deal with fluctuations in event transmission load, the broker node includes monitoring means that monitors fluctuations in event transmission load on the broker node for each event rule, and control means that dynamically changes an event topic to transmit the event in accordance with fluctuations in transmission load and notifies another node of an instruction of the change using a control message (event Topic control message).

### TECHNICAL FIELD

The present invention relates to a distributed event distribution system and particularly relates to a broker node and an event topic control method in a distributed event distribution system.

### BACKGROUND ART

Event distribution systems are widely used. Event distribution systems distribute fluctuations in a certain state (i.e., an event) such as fluctuations in score during a baseball game, fluctuations in stock prices or fluctuations in weather in real time and in a push manner from an event server (publisher) to an event client (subscriber). In such an event distribution system, an event is distributed from a Publisher to a Subscriber as follows:
1) send an Advertise message,
2) send a Subscribe message,
3) create a routing table,
4) send a Publish message, and
5) transmit a Publish message

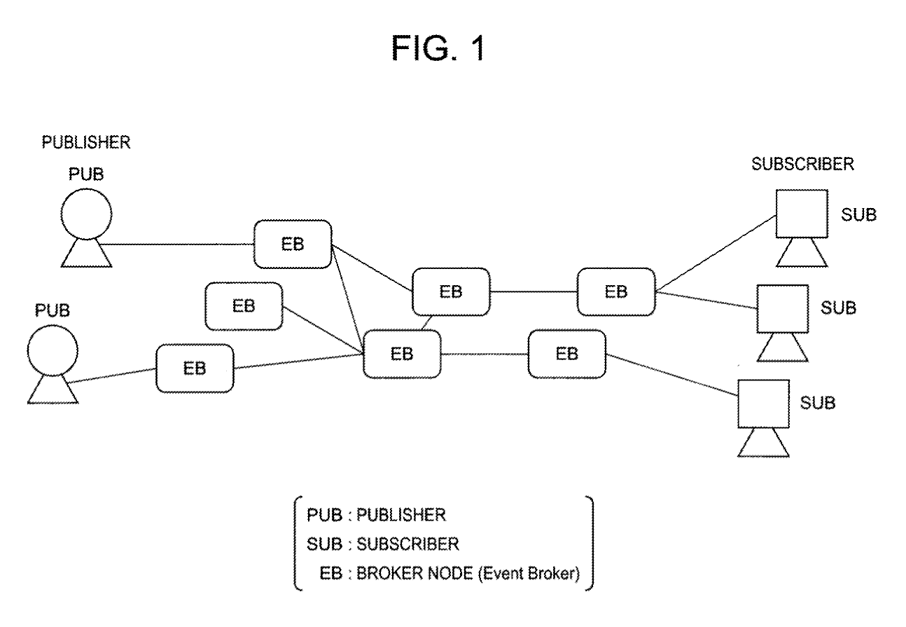

Event distribution systems are classified into centralized event distribution systems operated by a single server node and distributed event distribution systems operated by a plurality of broker nodes. Referring now to FIGS. 1 to 4, a distributed event distribution system is described briefly based on Non-Patent Literature (NPL) 1.

FIG. 1 illustrates an exemplary network configuration to describe a typical event distribution system. In this example, a plurality of Publishers PUB distribute an event to a plurality of Subscribers SUB via a network of a plurality of broker nodes EB. The following exemplifies a network including two Publishers (PUB_{X}, PUB_{Y}), two Subscribers (SUB_{Z}, SUB_{W}) and six broker nodes EB_{A} to EB_{E} for the sake of simplicity.

1) Sending of an Advertise Message

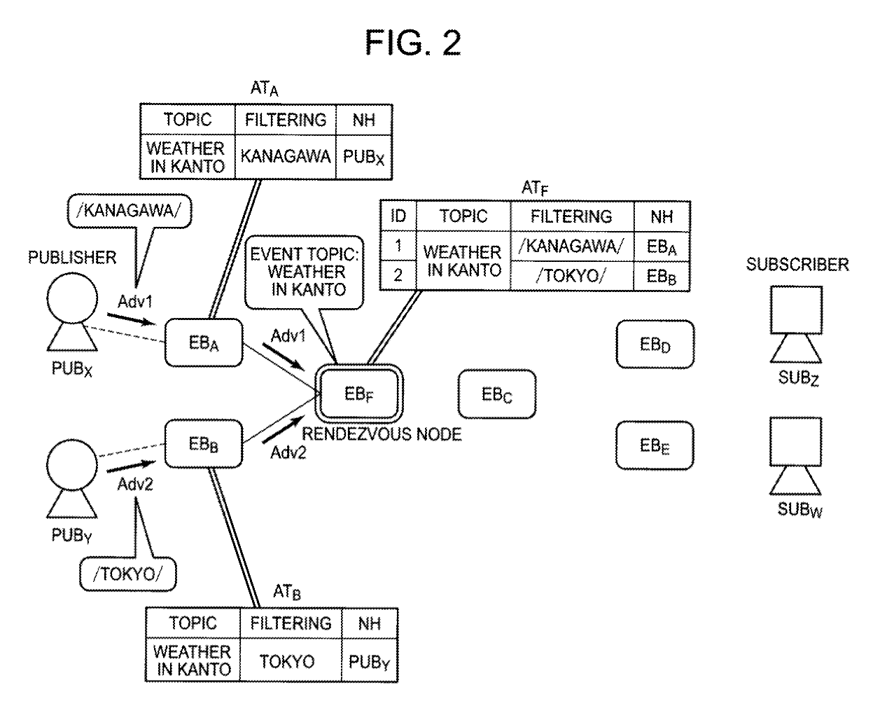

FIG. 2 is a network configuration diagram to describe sending of an Advertise message. A Publisher notifies, using an Advertise message, an event distribution system about what event is distributed. Firstly, a Publisher PUB decides an event Topic that the Publisher distributes (in this example, “weather in Kanto”), and includes the event topic in an Advertise message (Adv) and sends the Advertise message. The event Topic indicates a topic of information transmitted using the event Topic. Publishers and Subscribers use the same event Topic, thus enabling transmission and reception of events of the same topic. An event Topic may have a hierarchy relationship with other event Topics. This example exemplifies a hierarchy relationship where “weather in Kanto”, “weather in Tokai” and the like reside under “weather in Japan”, and “weather in Tokyo”, “weather in Yokohama” and the like reside under “weather in Kanto”.

When the event that the Publisher distributes is limited to narrower range of content in the event Topic, the Publisher may include a Filtering rule as well as the event Topic in the Advertise message. The Filtering rule may include any condition on the content of the event. Examples of the Filtering rule include a keyword included in the event and a time zone for transmission. When the event is written in XML, the Filtering rule may be written in Xpath. In the example of FIG. 2, PUB_{X} and PUB_{Y} designate “weather in Kanagawa” and “weather in Tokyo”, respectively, as the Filtering rules.

The Advertise message is firstly sent to a broker node with which the Publisher directly connects, and thereafter the broker node repeats transmission processing to distribute the Advertise message to a broker node called a rendezvous node. The rendezvous node is selected from a plurality of broker nodes for each event Topic as described later. When no broker node exists corresponding to the event Topic at the time of transmission of the Advertise message, a new broker node is selected. According to FIG. 2, PUB_{X} sends an Advertise message Adv₁ to a broker node EB_{A}, and EB_{A} transmits the Advertise message Adv₁ to a rendezvous node EB_{F}. Similarly, PUB_{Y} sends an Advertise message Adv₂ to a broker node EB_{B}, and EB_{B} transmits the Advertise message Adv₂ to the rendezvous node EB_{F}.

A broker node that transmits an Advertise message creates an Advertisement table AT at the time of transmission. The Advertisement table AT registers an event Topic and a Filtering rule included in the received Advertise message Adv as well as information to identify a node of a next preceding hop. In this example, at the broker node EB_{A}, an Advertisement table AT_{A} is created including information such as an event Topic “weather in Kanto”, a Filtering rule “Kanagawa” and “PUB_{X}” to identify a node of the next preceding hop and the like. Similarly at the broker node EB_{B} and at the rendezvous node EB_{F} as well, Advertisement tables AT_{B} and AT_{F} are created, respectively.

2) Sending of a Subscribe Message

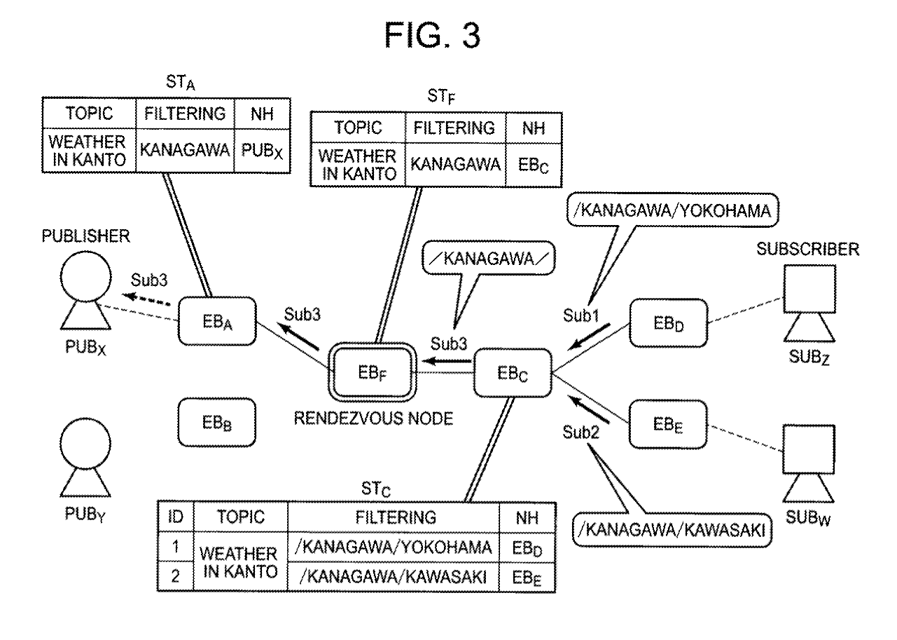

FIG. 3 is a network configuration diagram to describe sending of a Subscribe message. A Subscriber notifies, using a Subscribe message, an event distribution system about what event the Subscribes wants to receive. The Subscriber decides an event Topic that the Subscriber wants to receive, and includes the event Topic in the Subscribe message and sends the Subscribe message. When the event that the Subscriber wants to receive is limited to narrower range of content in the event Topic, the Subscriber may include a Filtering rule as well as the event Topic in the Subscribe message. In the example, SUB_{Z} designates “weather in Yokohama” as the Filtering rule in a Subscribe message Sub1, and SUB_{W} designates “weather in Kawasaki” as the Filtering rule in a Subscribe message Sub2.

Similarly to the Advertise message, broker nodes repeat transmission processing to distribute the Subscribe messages Sub1 and Sub2 to a rendezvous node EB_{F} corresponding to the event Topic. During this transmission processing, a broker node creates a routing table as described below.

Creation of a Routing Table

The event distribution system creates an event routing table for event distribution on the basis of the Advertise message and the Subscribe message. As illustrated in FIG. 2, a broker node that transmits an Advertise message creates an Advertisement table AT at the time of transmission. As illustrated in FIG. 3, a broker node creates a Subscription table ST at the time of transmission of a Subscribe message.

The Subscription table ST registers an event Topic and a Filtering rule included in the received Subscribe message Sub as well as information to identify a node of a next preceding hop. Herein, when a plurality of Subscribe messages Subs overlap in the regional range of their Filtering rules, the broker node merges the Filtering rules to suppress the table size or reduces the transmission frequency of a Subscribe message.

For instance, at a broker node EB_{C}, “Kanagawa/Yokohama” is registered as the Filtering rule of the Subscribe message Sub1, and “Kanagawa/Kawasaki” is registered as the Filtering rule of the Subscribe message Sub2. Accordingly, the broker node merges these Filtering rules “Yokohama” and “Kawasaki” with “Kanagawa”. Thereby, the number of Subscribe messages transmitted to the rendezvous node EB_{F} can be reduced to one (Sub3), and the number of table entries created at the rendezvous node EB_{F} also can be suppressed to one (Subscription Table ST_{F}).

The rendezvous node EB_{F} receiving the Subscribe message Sub3 refers to the Advertisement table ATF already created, whereby the rendezvous node EB_{F} can further transmit the Subscribe message Sub3 to a broker node EB_{A} ahead. Thereby, the Subscribe message Sub3 will be transmitted along a reverse path of the Advertise message, so that the Filtering rule that the Subscriber designates will be registered at a broker node along the path. As a result, the Publish message can be filtered near the Publisher, thereby preventing the distribution of unnecessary events.

The thus described operation allows an event distribution tree to be created from a Publisher to a Subscriber via a rendezvous node.

4) Sending of a Publish Message

When an event takes place, a Publisher sends a Publish message with an event Topic and an event to an event distribution system.

5) Transmission of a Publish Message

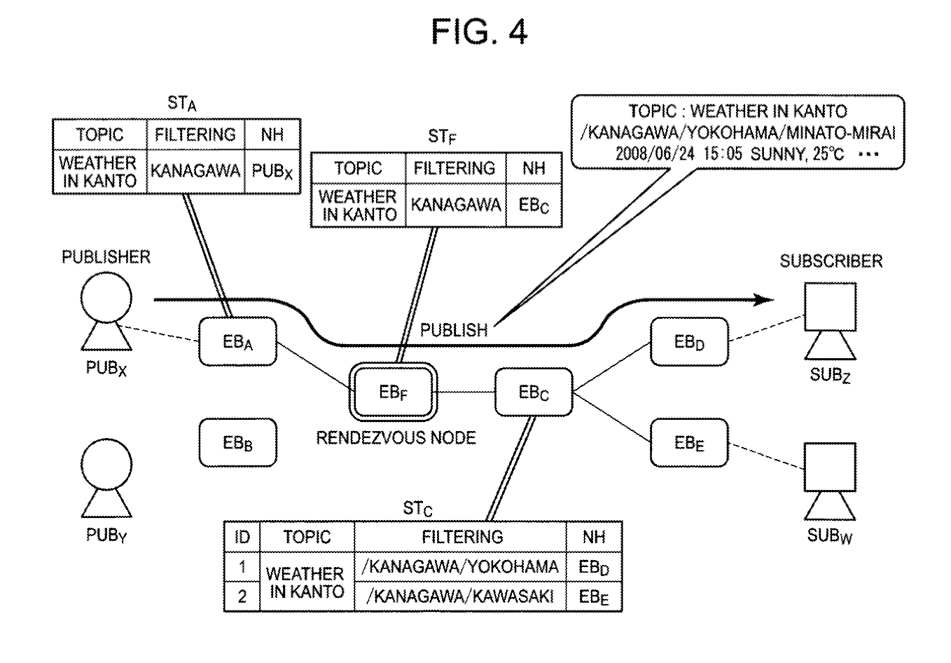

FIG. 4 is a network configuration diagram to describe transmission of a Publish message. As each of broker nodes EB_{A}, EB_{F} and EB_{C} refers to a Subscription table, the Publish message is transmitted successively. All of the Publish messages are basically distributed to the Subscriber via a rendezvous node.

A broker node performs transmission only when the event in the Publish message is included within the range of the Filtering rule described in the Subscription table. For instance, in FIG. 4, since the Filtering rule “Kanagawa/Kawasaki” advertised from the broker node EB_{E} does not include the event in the Publish message, the broker node EB_{C} does not transmit the Publish message to the broker node EB_{E}.

### CITATION LIST

### Non Patent Literature

NPL 1: Peter Pietzuch and Jean Bacon Hermes: A Distributed Event-Based Middleware Architecture 1st International Workshop on Distributed Event-Based Systems (DEBS'02), http://www.doc.ic.ac.uk/˜peter/manager/doc/prp-debs 2002-hermes.pdf

### SUMMARY OF INVENTION

### Technical Problem

It is important for the distributed event distribution system described in NPL 1 as stated above how to decide an event Topic. For instance, when an event regarding Weather in Japan is distributed, a wide range of event Topic such as “Weather in Japan” makes all of events included in “Weather in Japan” distributed to a rendezvous node. Therefore, when events take place frequently because of a typhoon approaching, for example, the Publish message transmission load on the rendezvous node will be increased greatly.

On the other hand, when a narrow range of event Topic such as “Weather in Yokohama” is selected, a rendezvous node is selected for each region, whereby the load on the rendezvous node can be distributed. However, a large number of event Topics coexist. As a result, the Filtering rules are not merged as stated above, and the number of Subscribe messages and the number of routing tables are increased.

In this way, in the aforementioned distributed event distribution system, the frequency of events taking place is estimated beforehand to decide an event Topic. That is, when high frequency is expected, an event Topic is made narrower to realize the load distribution at the rendezvous node. When low frequency is expected, an event Topic is made wider to suppress the number of Subscribe messages and a routing table size.

However, when the frequency of events taking place is higher than the original estimation, the load will concentrate at the rendezvous node, and when the frequency is lower, cost for the number of Subscribe messages, the routing table size and the like will be larger than the effect from the load distribution. In this way, the method of deciding an event Topic by estimating the frequency of events taking place beforehand cannot deal with fluctuations in the load situation flexibly.

Then, it is an object of the present invention to provide a broker node and an event topic control method capable of dealing with fluctuations in event transmission load flexibly in a distributed event distribution system.

### Solution to Problem

A broker node of the present invention includes: monitoring means that monitors fluctuations in transmission load of an event on the broker node for every event rule; and control means that dynamically changes an event topic to transmit the event in accordance with the fluctuations in transmission load and notifies another node of an instruction of the change using a control message.

An event topic control method of the present invention includes the steps of: monitoring fluctuations in transmission load of an event on the broker node for every event rule; dynamically changing an event topic to transmit the event in accordance with the fluctuations in transmission load; and notifying another node of an instruction of the change using a control message.

A Publisher node of the present invention resides in a distributed event distribution system including a plurality of broker nodes, and the Publisher node includes: advertise sending means that sends an Advertise message; publish sending means that sends a Publish message; and control means that, receiving a control message instructing to change an event topic from a broker node, controls to send an Advertise message including a new event topic or a merge destination event topic indicated with the control message while setting a rendezvous node indicated with the control message as a final destination, and send a Publish message in which a predetermined event topic indicated with the control message to use the new event topic or the merge destination event topic for event transmission is changed into the new event topic or the merge destination event topic.

A Subscriber node of the present invention resides in a distributed event distribution system including a plurality of broker nodes, and the Subscriber node includes: subscribe sending means that sends a Subscribe message; publish reception means that receives a Publish message; and control means that, receiving a control message instructing to change an event topic from a broker node, instructs to transmit a Subscribe message including a new event topic or a merge destination event topic indicated with the control message while setting a rendezvous node indicated with the control message as a final destination.

A distributed event distribution system of the present invention includes: a Publisher node that sends an Advertise message and a Publish message; a Subscriber node that sends a Subscribe message and receives the Publish message; and a plurality of broker nodes that transmit an event from the Publisher node to the Subscriber node. Each broker node includes: monitoring means that monitors fluctuations in transmission Load of an event on the broker node for every event rule; and control means that dynamically changes an event topic to transmit the event in accordance with the fluctuations in transmission load and notifies another node of an instruction of the change using a control message.

### ADVANTAGEOUS EFFECTS OF INVENTION

According to the present invention, fluctuations in event transmission load can be dealt with flexibly in a distributed event distribution system.

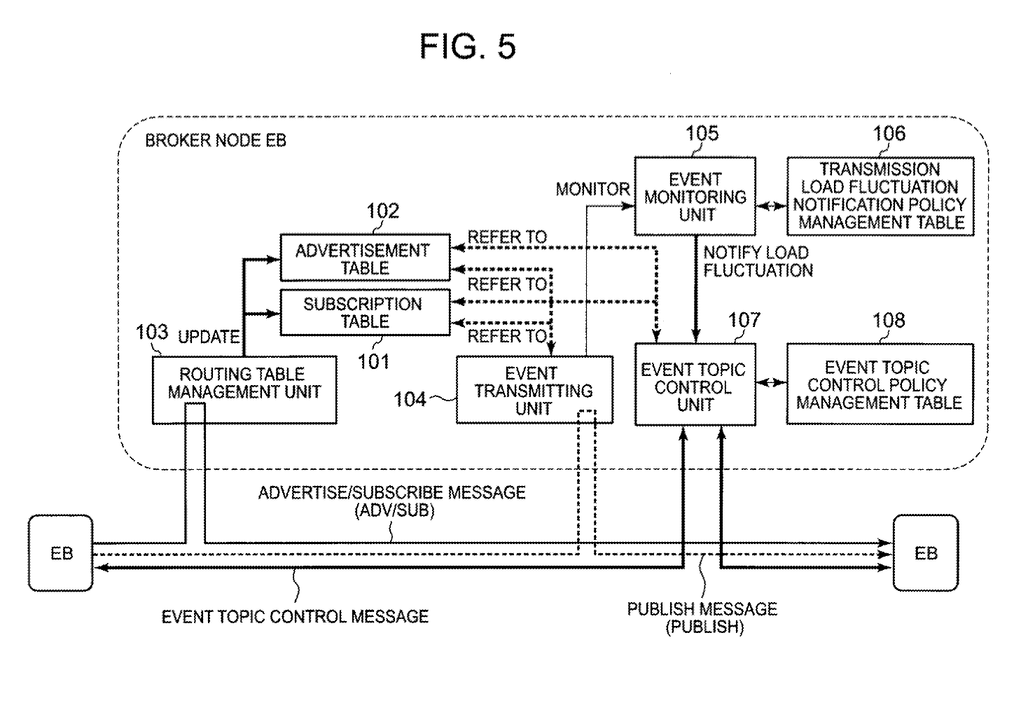

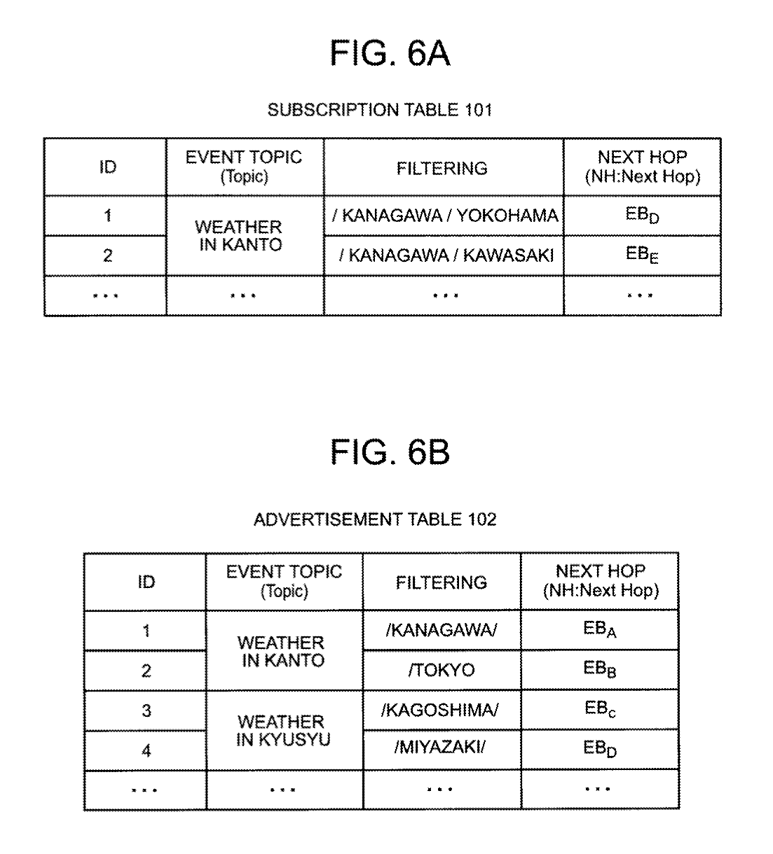

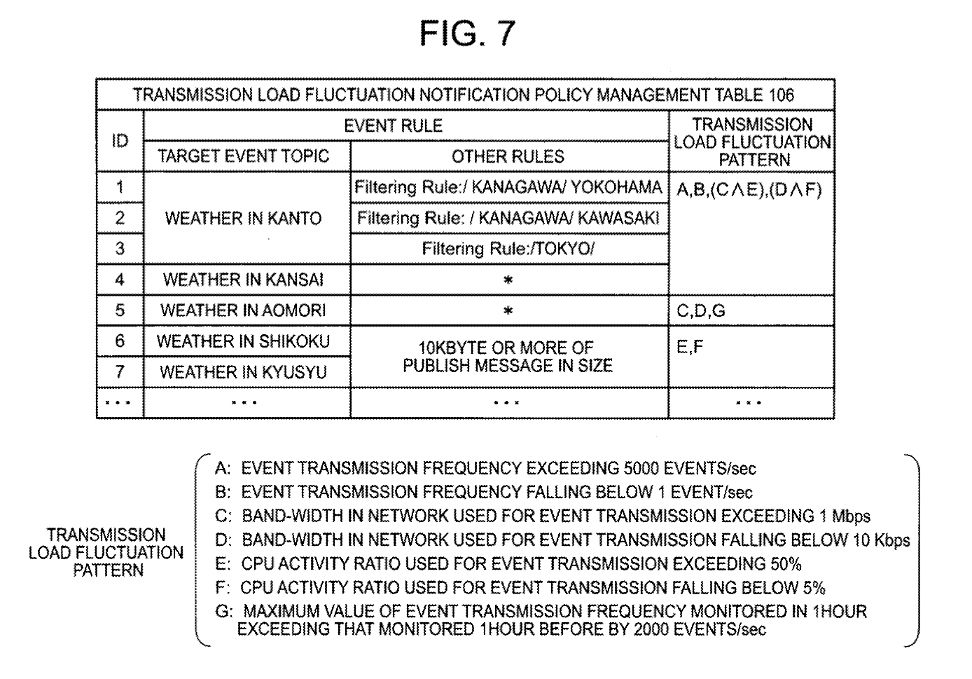

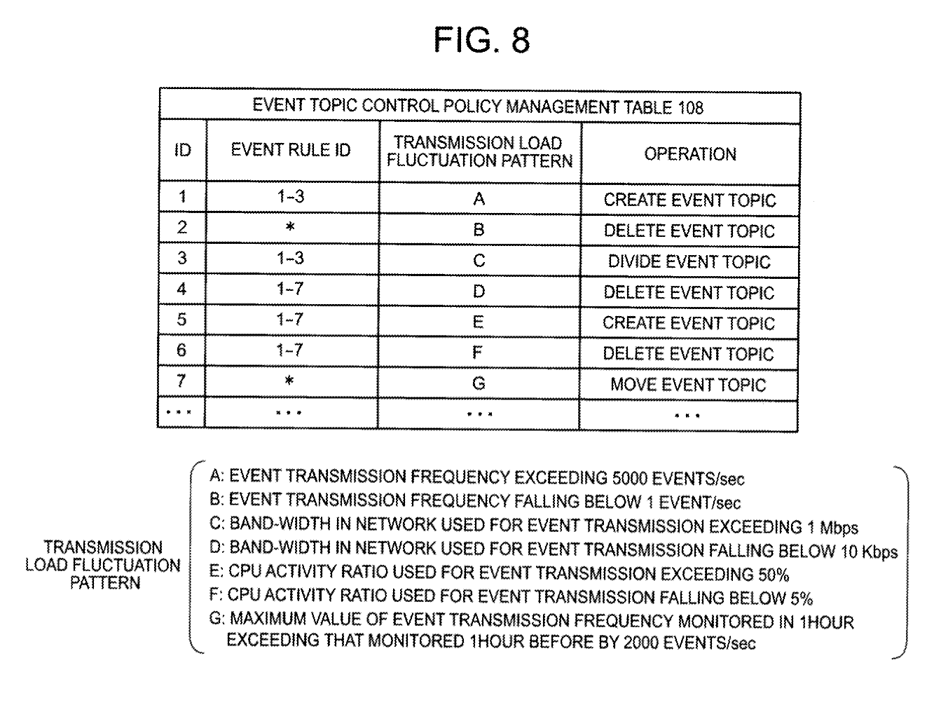

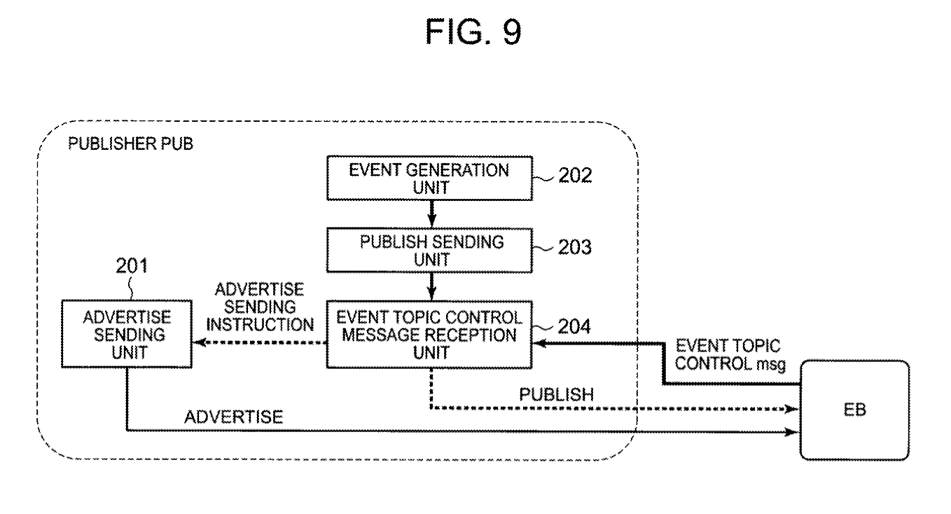

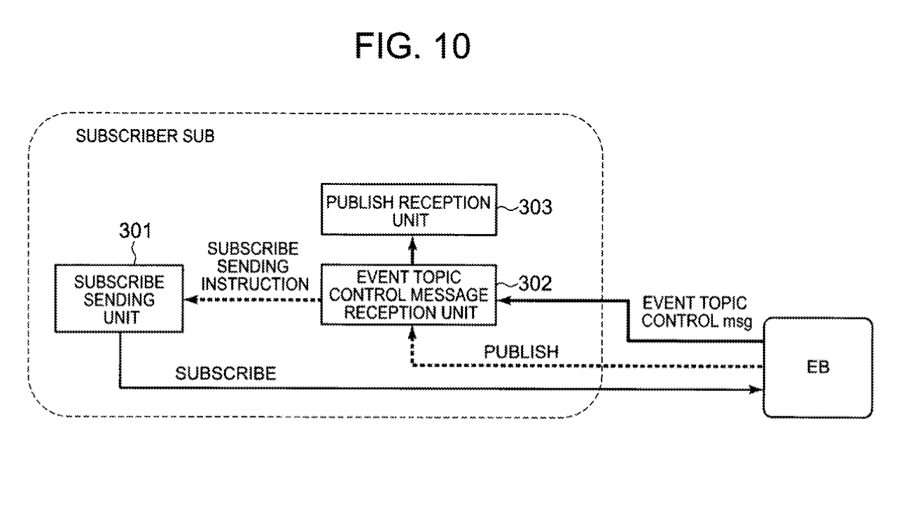

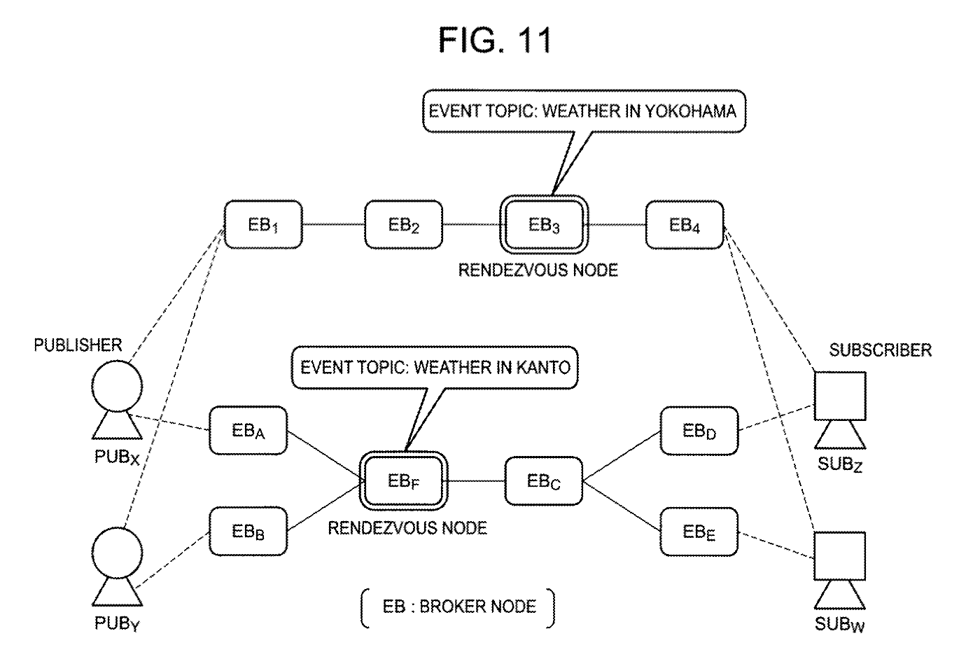

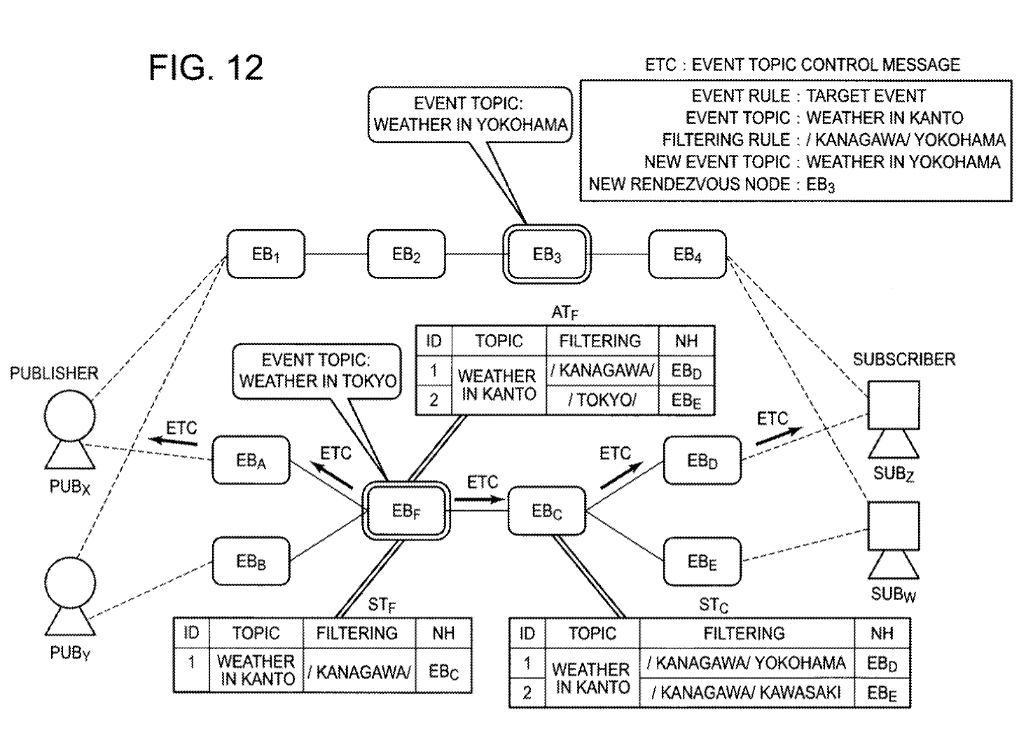

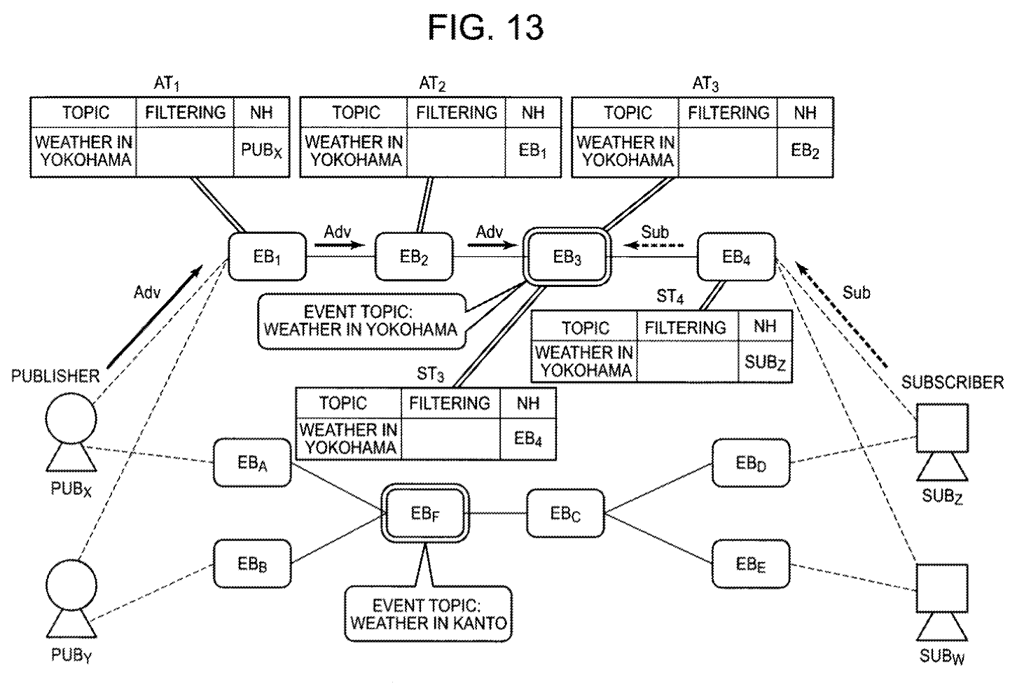

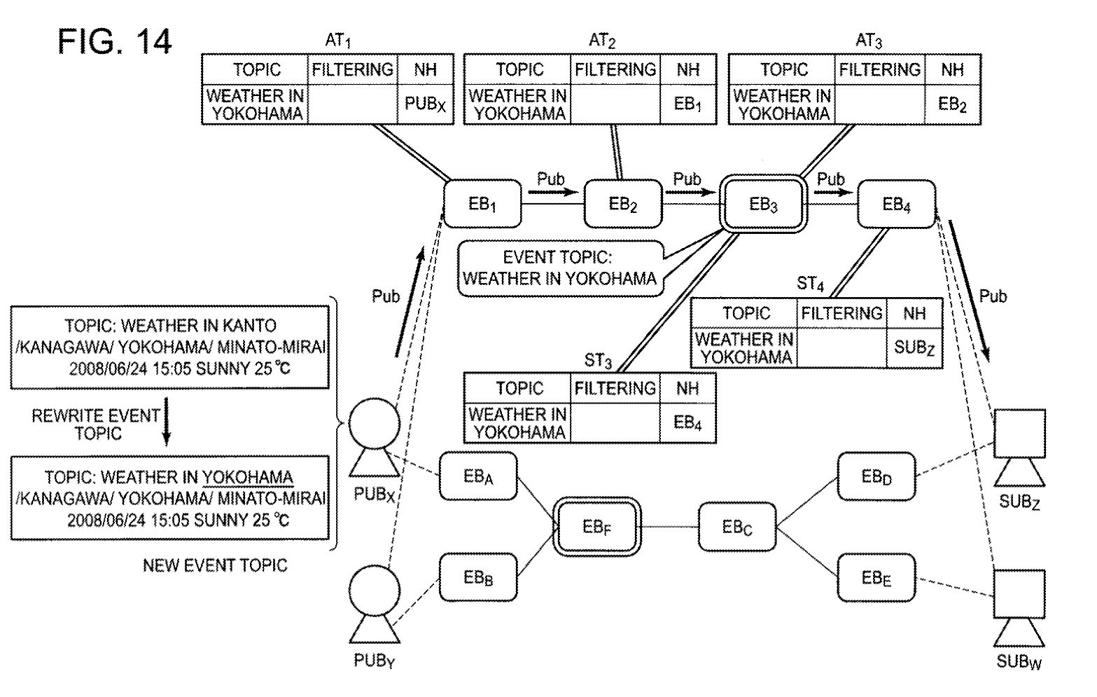

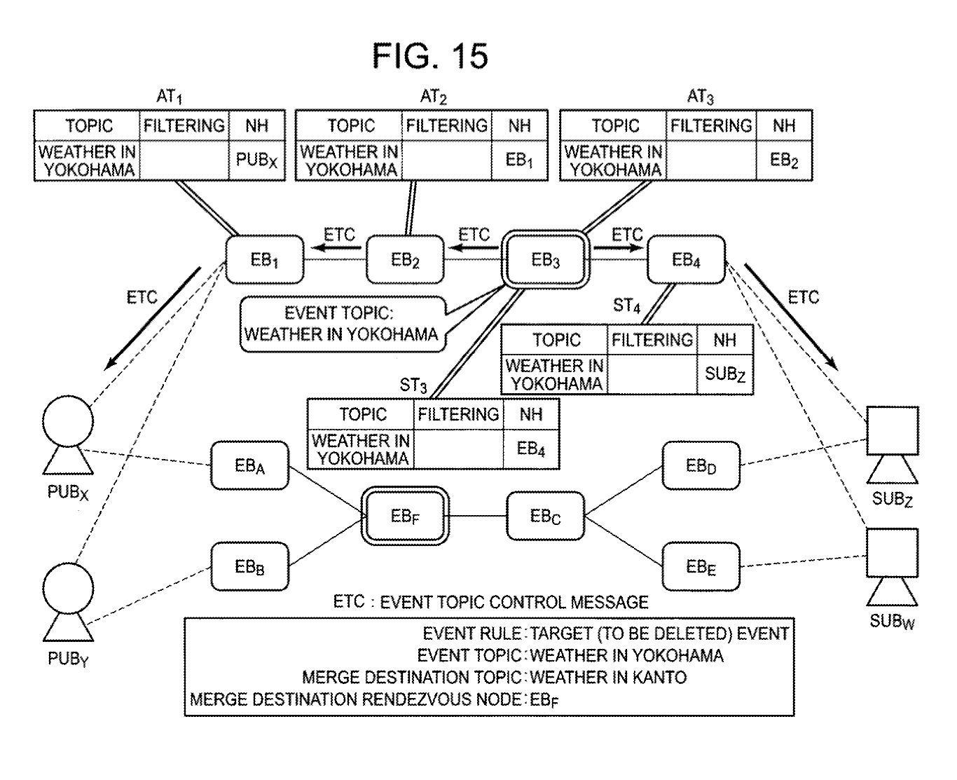

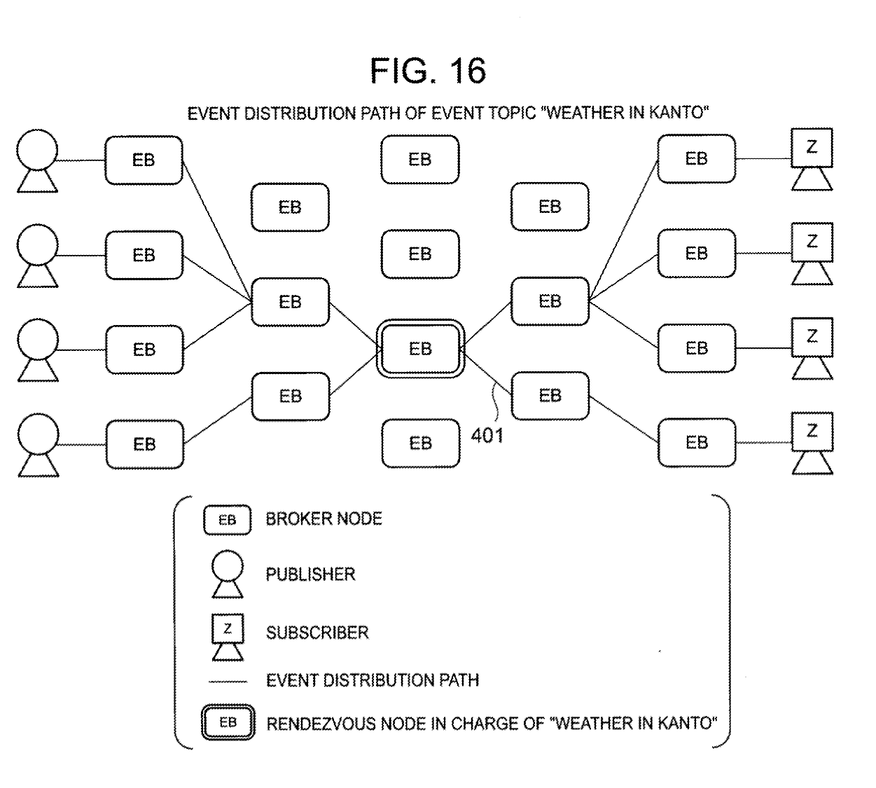

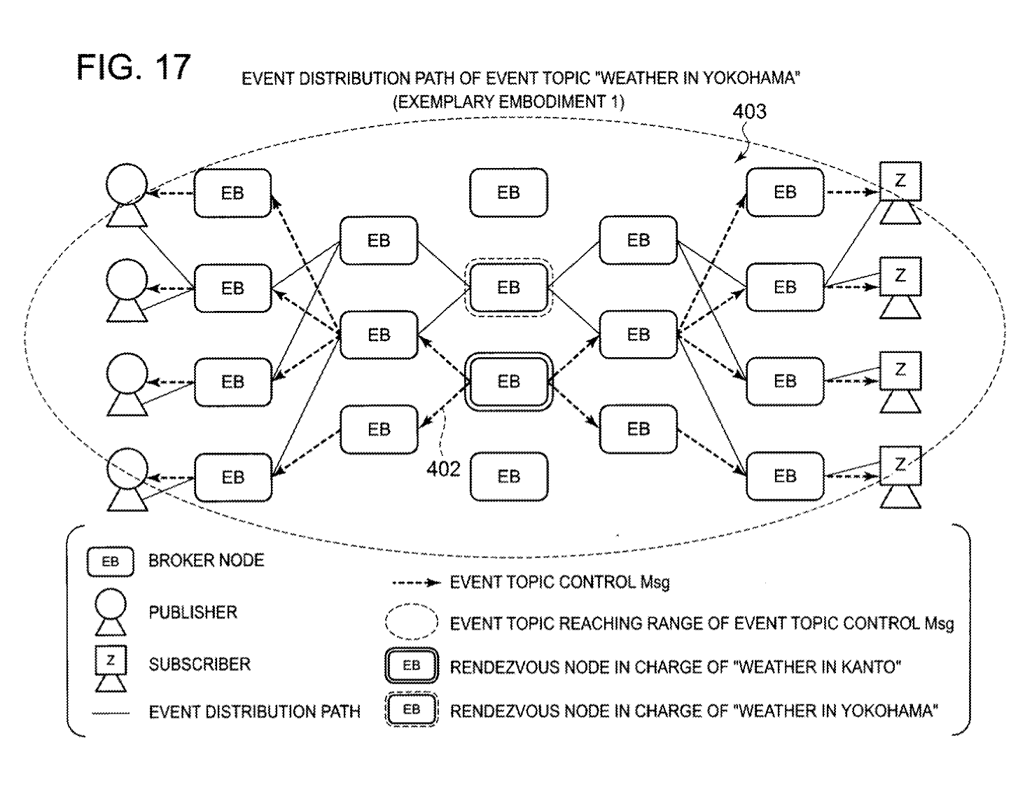

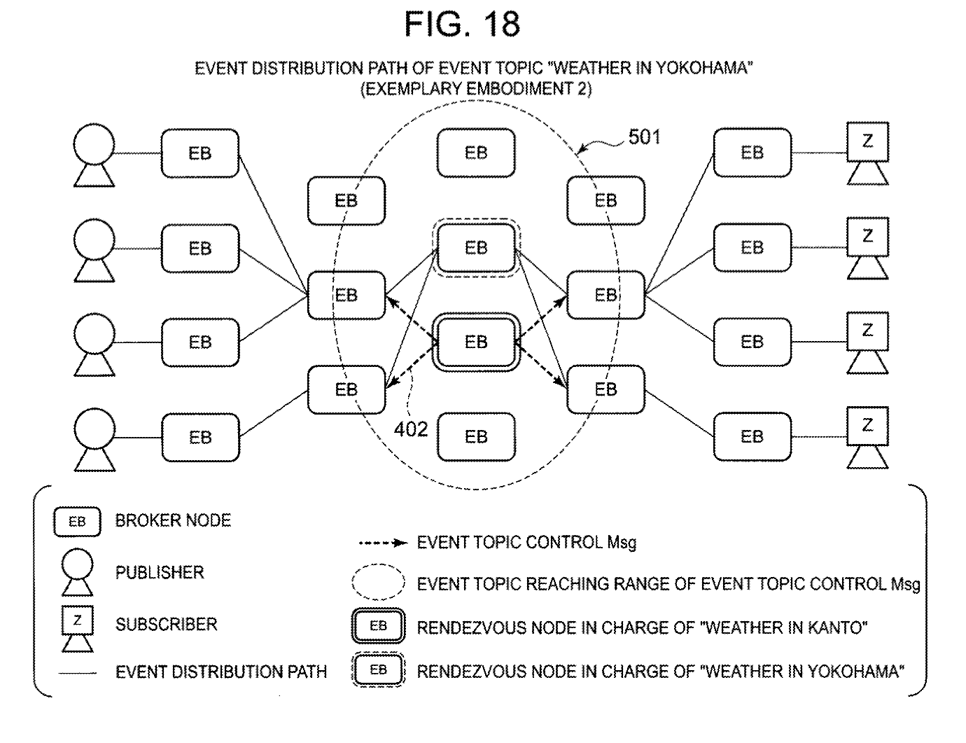

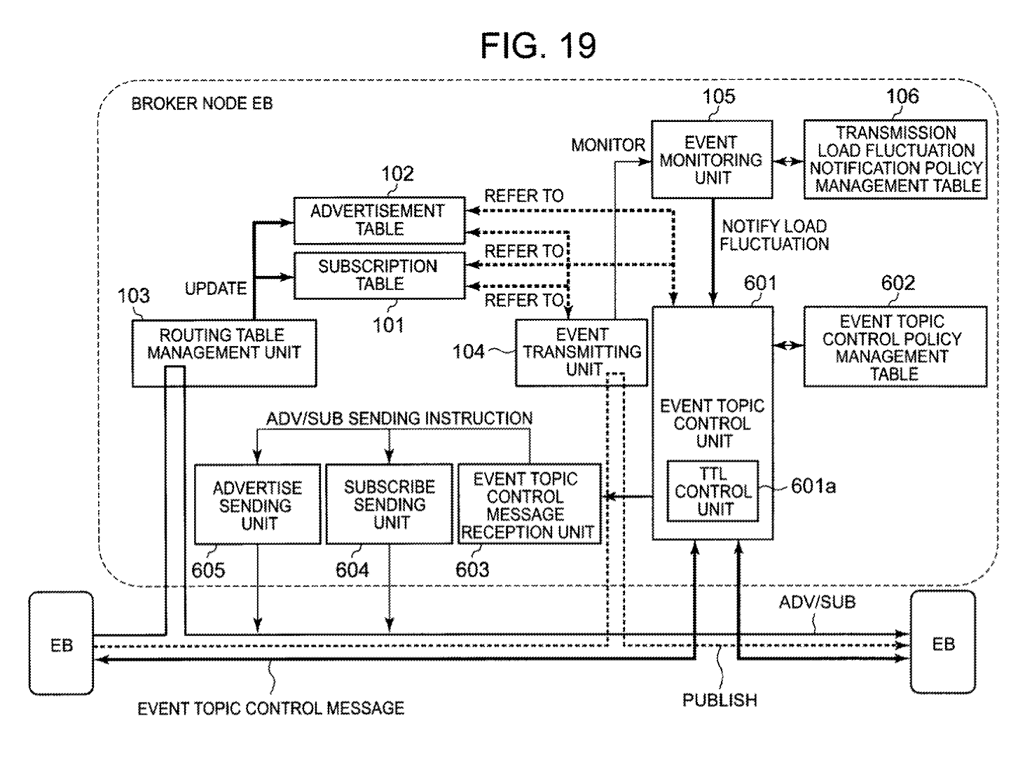

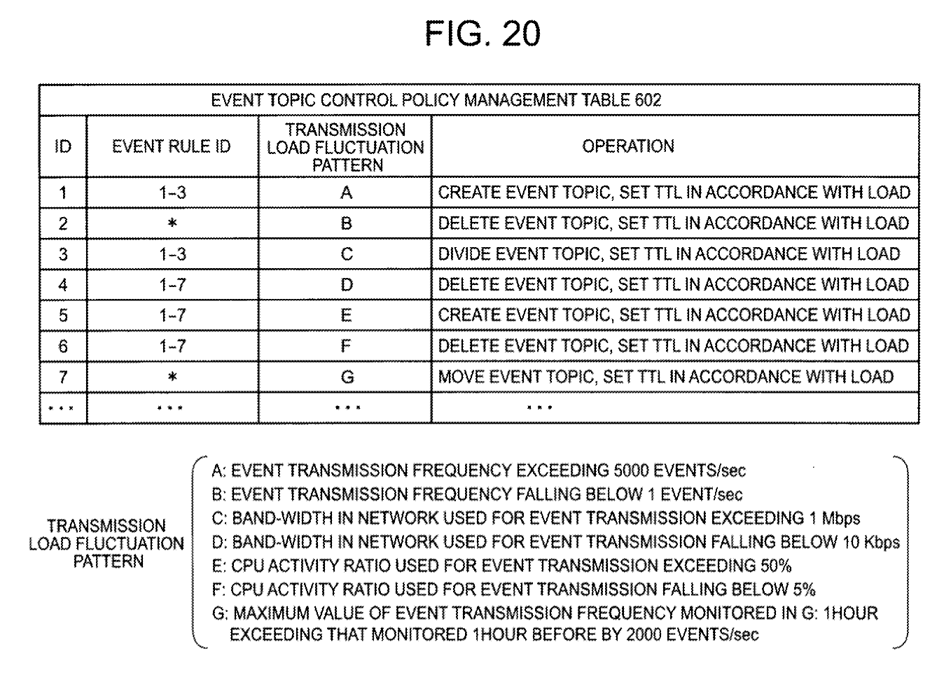

### BRIEF DESCRIPTION OF DRAWINGS

[FIG. 1] FIG. 1 illustrates an exemplary network configuration to describe a typical event distribution system.

[FIG. 2] FIG. 2 is a network configuration diagram to describe sending of an Advertise message.

[FIG. 3] FIG. 3 is a network configuration diagram to describe sending of a Subscribe message.

[FIG. 4] FIG. 4 is a network configuration diagram to describe transmission of a Publish message.

[FIG. 5] FIG. 5 is a block diagram illustrating a functional configuration of a broker node including an event Topic control unit according to Exemplary Embodiment 1 of the present invention.

[FIG. 6] FIG. 6(A) illustrates an exemplary Subscription table and FIG. 6(B) illustrates an exemplary Advertisement table.

[FIG. 7] FIG. 7 illustrates an exemplary notification policy set in a transmission load fluctuation notification policy management table.

[FIG. 8] FIG. 8 illustrates an exemplary control policy set in an event Topic control policy management table.

[FIG. 9] FIG. 9 is a block diagram schematically illustrating a functional configuration of a Publisher in the present exemplary embodiment.

[FIG. 10] FIG. 10 is a block diagram schematically illustrating a functional configuration of a Subscriber in the present exemplary embodiment.

[FIG. 11] FIG. 11 is a network diagram illustrating creation procedure of a new event Topic in a distributed event distribution system according to the present exemplary embodiment.

[FIG. 12] FIG. 12 is a network diagram describing transmission procedure of an event Topic control message in a distributed event distribution system according the present exemplary embodiment.

[FIG. 13] FIG. 13 is a network diagram describing configuration procedure of an event distribution path in a distributed event distribution system according the present exemplary embodiment.

[FIG. 14] FIG. 14 is a network diagram describing event transmission procedure in a distributed event distribution system according the present exemplary embodiment.

[FIG. 15] FIG. 15 is a network diagram describing deletion procedure of an event Topic in a distributed event distribution system according the present exemplary embodiment.

[FIG. 16] FIG. 16 is a network diagram illustrating an event distribution path of the event Topic “Weather in Kanto”.

[FIG. 17] FIG. 17 is a network diagram illustrating an event distribution path of the event Topic “Weather in Yokohama” in Exemplary Embodiment 1 of the present invention.

[FIG. 18] FIG. 18 is a network diagram illustrating an event distribution path of the event Topic “Weather in Yokohama” in Exemplary Embodiment 2 of the present invention.

[FIG. 19] FIG. 19 is a block diagram illustrating a functional configuration of a broker node including an event Topic control unit according to Exemplary Embodiment 2 of the present invention

[FIG. 20] FIG. 20 illustrates an exemplary control policy set in an event Topic control policy management table.

### DESCRIPTION OF EMBODIMENT

### 1. Exemplary Embodiment 1

In a network as illustrated in FIG. 1, a broker node EB according to the present exemplary embodiment is provided with an event monitoring unit and an event Topic control unit described later. As described above, an event Topic indicates a topic of information transmitted using the event Topic. Publishers and Subscribers use the same event Topic, thus enabling transmission and reception of events of the same topic. An event Topic may have a hierarchy relationship with other event Topics.

The event monitoring unit measures a load on its own node when an event corresponding to a predetermined rule (hereinafter called an event rule) is transmitted, and when fluctuations in transmission Load for the event rule matches with a predetermined pattern (hereinafter called a transmission load fluctuation pattern), the event monitoring unit notifies the event Topic control unit of the event rule and the transmission load fluctuation pattern. The event monitoring unit may estimate that the transmission load of the event corresponding to the predetermined event rule matches with the predetermined transmission load fluctuation pattern on the basis of a predetermined policy (transmission load fluctuation estimation policy), and may notify the event Topic control unit of the event rule and the transmission load fluctuation pattern.

Receiving a notification from the event monitoring unit, the event Topic control unit creates an event Topic newly or deletes an event Topic, and sends an event Topic control message so as to notify of a broker node, a Publisher and a Subscriber relating to the event Topic of the newly creation or the deletion. Receiving an event Topic control message from another broker node, the event Topic control unit transmits the message to another broker node, a Publisher or a Subscriber.

In this way, the broker node EB of the present exemplary embodiment dynamically changes an event Topic in accordance with fluctuations in the load of event transmission, and notifies another node of an instruction of the change, and therefore the broker node can deal with fluctuations in the load of event transmission flexibly. The following describes the configuration and the operation of the broker node in detail.

1.1) Configuration of a Broker Node

FIG. 5 is a block diagram illustrating a functional configuration of a broker node including an event Topic control unit according to Exemplary Embodiment 1 of the present invention. FIG. 6(A) illustrates an exemplary Subscription table and FIG. 6(B) illustrates an exemplary Advertisement table.

In FIG. 5, a broker node EB is configured to have functions as a Subscription table 101, an Advertisement Table 102, a routing table management unit 103 and an event transmitting unit 104, and further as an event monitoring unit 105 and a transmission load fluctuation notification policy management table 106 as well as an event Topic control unit 107 and an event Topic control policy management table 108. As illustrated in FIG. 6, the Subscription table 101 and the Advertisement Table 102 register information on an event Topic, a Filtering rule and a next hop for each entry ID.

The routing table management unit 103 transmits an Advertisement message and a Subscribe message received from an adjacent broker node EB, a Subscriber or a Publisher, and updates the Subscription table 101 or the Advertisement Table 102 on the basis of information included in the received message.

When receiving an Advertise message, the routing table management unit 103 registers an event Topic and a Filtering rule included in the Advertise message and an adjacent node that transmits the Advertise message to its own node as a Next hop in the Advertisement Table 102.

When receiving a Subscribe message, the routing table management unit 103 registers an event Topic and a Filtering rule included in the Subscribe message and an adjacent node that transmits the Subscribe message to its own node as a Next hop in the Subscription table 101.

Herein, when an event Topic and a Next hop of an entry that is already registered in the Subscription table 101 are the same as those in the received Subscribe message, a Filtering rule in the entry can be merged with a Filtering rule included in the received Subscribe message. For instance, let that an entry. including an event Topic “weather in Kanto” and a Filtering rule “/Kanagawa/Yokohama” is already registered in the Subscription table 101. Then, when a Subscribe message including an event Topic “weather in Kanto” and a Filtering rule “/Kanagawa/Kawasaki” is received, an entry where the Filtering rule is merged as “/Kanagawa/” can be created, and the existing entry can be deleted. Thereby, an increase in size of the Subscription table 101 can be suppressed and a time required for table search can be saved.

The received Subscribe message is transmitted to an adjacent broker node along a path from its own node to a rendezvous node. Herein, when the event Topic in the Subscribe message is the same as in the entry already registered in the Subscription table and the Filtering rule F_sx in the entry and the Filtering rule F_sy of the Subscribe message have a relationship of “F_sy is included in F_sx (F_sy⊂F_sx)”, the Subscribe message is not transmitted. For instance, when F_sy is /Yokohama/ and F_sx is /Kanagawa/, the Subscribe message is not transmitted.

When receiving a Subscribe message after reaching a rendezvous node once, such a Subscribe message can be transmitted to a Next hop registered in the entry of the same event Topic by referring to the Advertisement Table 102. Herein, when the overlapping of the Filtering rule F_sy of the Subscribe message with the Filtering rule F_sz of the entry is a null set (F_sy∩F_sz=φ), the Subscribe message is not transmitted.

When receiving a Publish message from an adjacent broker node EB or a Publisher, the event transmitting unit 104 refers to the Subscription table 101 and searches for an entry having the same event Topic as that in the received Publish message and having the event corresponding to the Filtering rule. Then, the event transmitting unit 104 transmits the Publish message to the Next hop registered in the searched entry.

The following is a detailed description on the event monitoring unit 105 and the transmission load fluctuation notification policy management table 106 as well as the event Topic control unit 107 and the event Topic control policy management table 108 in the event Topic control device according to the present exemplary embodiment.

1.2) Event Monitoring Unit of a Broker Node

When an event corresponding to a predetermined rule (hereinafter called an event rule) is transmitted, the event monitoring unit 105 measures a load on its own node. Then, the event monitoring unit 105 determines whether fluctuations in transmission load regarding the event rule matches with a predetermined pattern (hereinafter called a transmission load fluctuation pattern) registered in the transmission load fluctuation notification policy management table 106 or not. When the fluctuations in transmission load regarding the event rule match with the transmission load fluctuation pattern, the event monitoring unit 105 notifies the event Topic control unit 107 of the event rule and the transmission load fluctuation pattern.

A transmission load fluctuation estimation policy may be registered in the transmission load fluctuation notification policy management table 106, and the event monitoring unit 105 may estimate that fluctuations in transmission load concerning the predetermined event rule matches with the predetermined transmission load fluctuation pattern on the basis of the transmission load fluctuation estimation policy. In this case, the event monitoring unit 105 notifies the event Topic control unit 107 of the event rule and the estimated transmission load fluctuation pattern.

### Event Rule

To begin with, an event rule is described below. Example of the event rule are as follows.

(1) Event Topic

Event Topic itself, which is always set.

(2) Filtering rule

(a) A Filtering rule registered in a Subscription table or an Advertisement table; any condition advertised by a Publish message that an event should satisfy; a keyword included in an event or a time zone for transmission. When the event content is written in XML, a rule written in Xpath may be considered.

(b) Filtering rule set beforehand: the same as the above (2.a)

(3) Rules based on an attribute of a Publish message

Not the event content itself but attribute information on a Publish message transporting an event, e.g., rules for header information of TCP, UDP and IP as well as HTTP and SIP:

(a) Size of a Publish message;

(b) Sender Subscriber of a Publish message;

(c) Type of a file attached with a Publish message (static images, moving images and sound)

Other various rules can be considered. An event rule can be represented by the combination of an event Topic in the above (1) with other rules. That is, each event rule always includes an event Topic. A single event rule may designate a plurality of event Topics. Hereinafter, an event Topic designated in an event rule is called a “target event Topic”,

### Transmission Load Fluctuation Pattern

Examples of load measured by the event monitoring unit 105 include the following parameters.
Frequency: frequency of transmission of an event corresponding to the aforementioned event rule per unit time.
Network band-width: a band-width in the network occupied for transmission of an event corresponding to the aforementioned event rule.
CPU time: a CPU time required for transmission of an event corresponding to the aforementioned event rule. For instance, a CPU time increases with an increase in complexity of a Filtering rule applied to the event.

Other various parameters may be considered as the load measured. These parameters may be used alone or a plurality of parameters may be combined for the measurement.

Examples of transmission load fluctuation pattern are as follows.

(1) Transmission load exceeding or falling below a threshold set beforehand.

(2) A difference between a minimum value and a maximum value of transmission load in a certain time period, i.e., a fluctuation width of transmission load exceeding or falling below a threshold set beforehand.

Other various parameters may be considered as the transmission load fluctuation pattern. These patterns may be used alone or a plurality of patterns may be combined for the use as one transmission load fluctuation pattern.

The transmission load fluctuation notification policy management table 106 registers a notification policy indicating for each event rule that the event Topic control unit 107 is to be notified about what transmission load fluctuation pattern is detected.

FIG. 7 illustrates an exemplary notification policy set in the transmission load fluctuation notification policy management table. For instance, at an entry of ID=1, transmission load of an event matching with the event Topic “Weather in Kanto” and the Filtering rule “/Kanagawa/Yokohama” matches with any one of patterns of A, B, (CΛE) and (DΛF), notification to the event Topic control unit 107 occurs. At entries of ID=4 and ID=5, an event Topic only is included as an event rule.

In one example, (CΛE) represents AND of C and E, meaning the following pattern. That is, the event monitoring unit 105 measures the band-width in the network and the CPU activity ratio used for event transmission and refers to the transmission load fluctuation notification policy management table 106 to determine whether the band-width in the network at the corresponding rule exceeds 1 Mbps or not (pattern C) and the CPU activity ratio exceeds 50% or not (pattern E). When both of the patterns C and E are satisfied (CΛE), the event monitoring unit 105 notifies the event Topic control unit 107 of the event rule and the transmission load fluctuation pattern of the (CAE).

### Estimation Policy

An estimation policy includes a predetermined observable event and an estimation event. When an event as the predetermined observable event is observed, the event monitoring unit 105 deems that an event as an estimated event has occurred or will occur in the future.

Predetermined observable events are as follows.
Transmission of an event corresponding to an event rule.
Transmission load of an event corresponding to an event rule matching with a transmission load fluctuation pattern.

Other various events may be considered as the predetermined observable events. These events may be used alone or a plurality of events may be combined for the use of one predetermined observable event.

An estimated event is fluctuations in transmission load for a predetermined event rule.

An predetermined observable event and an estimated event may be combined variously for use. For instance, a single estimated event may be estimated from a plurality of predetermined observable events or a plurality of estimated events may be estimated from a single predetermined observable event. A single estimated event may be estimated using a logical expression including the combination of a plurality of predetermined observable events with logical symbols such as AND and OR. For instance, IF (observable event A AND observable event B), THEN (estimated event C); that is, if observable event A and observable event B are observed, then the occurrence of estimated event C is estimated. An estimated event may be estimated based on a time-series condition for a plurality of predetermined observable events. For instance, if event B is observed within 10 minutes after observation of event A, then the occurrence of event C within 1 hour after the observation is estimated.

1.3) Event Topic Control Unit of a Broker Node

Receiving a load fluctuation notification from the event monitoring unit 105, the event Topic control unit 107 refers to the event Topic control policy management table 108 to newly create or delete an event Topic, and sends an event Topic control message as described later. The event Topic control message allows a broker node EB, a Publisher or a Subscriber relating to the event Topic to be notified about the newly creation or deletion of an event Topic.

Receiving an event Topic control message from another broker node EB, the message is transmitted to another broker node EB, a Publisher or a Subscriber.

The event Topic control policy management table 108 includes a control policy set therein, describing the notification from the event monitoring unit 105 and the operation of the event Topic control unit 107, and the event Topic control unit 107 follows this control policy to create and delete an event Topic.

### Control Policy

FIG. 8 illustrates an exemplary control policy set in the event Topic control policy management table.

In a control policy, a relationship between the following two operations and the notification from the event monitoring unit 105 is set.

(1) An event Topic created or deleted.

(2) Transmission load fluctuation pattern advertised from the event monitoring unit 105.

When a notification of transmission load exceeding a threshold (or exceeding is estimated in the future) is made as a transmission load fluctuation pattern or when a notification of transmission load increasing more than a fluctuation width set as a threshold (or increasing is estimated in the future) is made as a transmission load fluctuation pattern, an event Topic having the transmission load fluctuation pattern corresponding to an event rule measured or estimated is newly created. For instance, when it is notified that transmission load of an event matching with an event rule of the event Topic “Weather in Kanto” and the Filtering rule “Kanagawa/Yokohama/” exceeds a threshold, an event Topic corresponding to the event “Weather in Yokohama” is newly created.

When a notification of transmission load falling below a threshold (or falling below is estimated in the future) is made as a transmission load fluctuation pattern or when a notification of transmission load decreasing more than a fluctuation width set as a threshold (or decreasing is estimated in the future) is made as a transmission load fluctuation pattern, an event Topic having the transmission load fluctuation pattern corresponding to an event rule measured or estimated is deleted. For instance, when it is notified that transmission load of an event matching with an event rule of the event Topic “Weather in Yokohama” falls below a threshold, the event Topic “Weather in Yokohama” is deleted.

### Creation or Deletion of an Event Topic

When the notification from the event monitoring unit 105 is actually measured (or estimated as an event currently taking place), the event Topic control unit 107 immediately creates or deletes an event Topic. When the notification is estimated to occur in the future, the event Topic control unit 107 creates or deletes an event Topic at a timing included in the notification. For instance, it is notified that estimated event A occurs after 10 minutes, the event Topic control unit 107 creates or deletes an event Topic after 10 minutes.

### Creation or Deletion of an Event Topic Control Message

When an event Topic is newly created, a rendezvous node (new rendezvous node) in charge of the new event Topic is selected from other broker nodes EB. Then, the newly created event Topic and the new rendezvous node as well as an event rule (including a target event Topic) advertised from the event monitoring unit 105 are included in the event Topic control message and notification of creation of the new event Topic is made to another node.

When an event Topic is deleted, an event Topic matching with the event Topic to be deleted (hereinafter called a merge destination event Topic) is decided from existing event Topics. For instance, an event Topic “Weather in Yokohama” is deleted, “Weather in Kanto” is selected as a merge destination event Topic from existing event Topics. Therefore, after the deletion, an event transmitted using the event Topic “Weather in Yokohama” is transmitted using “Weather in Kanto”. Subsequently, the event Topic control unit 107 transmits an event Topic control message with the merge destination event Topic and the event rule advertised from the event monitoring unit 105 (when a target event Topic is included, such a target event Topic becomes an event Topic to be deleted) to notify another node of the deletion of existing event Topic.

Herein, the creation and the deletion of an event Topic may be performed simultaneously. For instance, one event Topic control message may be used to make a notification of both of the deletion of an event Topic and the creation of an event Topic and may notify about a newly created event Topic as a merge destination event Topic of the event Topic to be deleted, whereby event Topics can be moved.

Further, a notification of the creation and the deletion of a plurality of event Topics may be made simultaneously. An existing event Topic is deleted and a plurality of event Topics are newly created, and a notification of the plurality of event Topics created newly may be made as a merge destination event Topic, whereby an existing event Topic may be divided into a plurality of event Topics.

As illustrated in FIG. 8, operation of the event Topic control unit 107 is set for each event rule and each transmission load fluctuation pattern. For instance, at an entry of ID=1, policy is set, indicating when the transmission load fluctuation pattern of an event corresponding to the event rule ID=1-3 illustrated in FIG. 7 matches with the transmission load fluctuation pattern A, an event Topic is newly created. As in entries of ID=2, ID=7, a wild card (* mark) or the like may be used to include the operation when fluctuations in transmission load matches with a predetermined transmission load fluctuation pattern for any event rule.

### Transmission of an Event Topic Control Message

The event Topic control unit 107 refers to the Subscription table 101 and the Advertisement Table 102 to transmit an event Topic control message. When a new event Topic is created, an entry corresponding to a target event Topic included in the event Topic control message is searched from the Subscription table 101 and/or the Advertisement Table 102, and the event Topic control message is transmitted to a Next hop included in the entry.

When the Filtering rule (F_p) included in the searched entry and the rule (F_q) included in the event Topic control message do not have an overlapping range, i.e., when F_p∩F_q=φ (null set), there is no need to transmit the event Topic control message to the Next hop included in the entry. This is because the Next hop does not transmit an event using the new event Topic (more specifically, transmit an event corresponding to a rule included in the event Topic control message). Thereby, the frequency of transmission of an event Topic control message can be suppressed.

When an existing event Topic is deleted, an entry corresponding to a target event Topic included in the event Topic control message is retrieved from the Subscription table 101 and/or the Advertisement Table 102, and the event Topic control message is transmitted to a Next hop included in the entry. With the transmission of the event Topic control message as an impetus, an entry corresponding to an event Topic to be deleted may be deleted from the Subscription table 101 and the Advertisement Table 102 immediately after the transmission of the event Topic control message or after a certain time elapsed from the transmission. Thereby, unnecessary entries can be deleted promptly and there is no need for a Publisher and a Subscriber to send an Advertise message and a Subscribe message (i.e., an Advertise message and a Subscribe message including that events of the event Topic to be deleted will be no longer sent/received) to delete unnecessary entries, and therefore traffic occurring by the transmission of the message can be suppressed. Herein, when deletion is not performed with the transmission of an event Topic control message as an impetus, deletion may be performed at timing when an Advertise message and a Subscribe message including that events of the event Topic to be deleted will be no longer transmitted/received are transmitted.

The aforementioned functions of the routing table management unit 103, the event transmitting unit 104, the event monitoring unit 105 and the event Topic control unit 107 may be implemented by executing programs on a program control processor such as a CPU.

2. Configuration of a Publisher

FIG. 9 is a block diagram schematically illustrating a functional configuration of a Publisher in the present exemplary embodiment. A Publisher PUB includes an Advertise sending unit 201, an event generation unit 202, a Publish sending unit 203 and an event Topic control message reception unit 204.

The Advertise sending unit 201 includes an event Topic in an Advertise message and sends the Advertise message to a broker node directly connecting therewith while setting a rendezvous node in charge of the event Topic as a final destination.

The event generation unit 202 detects fluctuations in a certain state, i.e., an event, and notifies the Publish sending unit 203 of the event. Examples of the event generation unit 202 include a sensor device that detects fluctuations in weather, an application that detects the presence of a user and the like.

The Publish sending unit 203 includes the event advertised from the event generation unit 202 as well as an event Topic corresponding to the event in a Publish message, and sends the Publish message to a broker node directly connecting with its own node. An event Topic may include a single value set beforehand, or may include a rule to decide an event Topic in accordance with event.

The event Topic control message reception unit 204 receives an event Topic control message from a broker node, changes and transmits an event Topic of a Publish message that the Publish sending unit 203 sends, and instructs the Advertise sending unit 201 to send an Advertise message.

### Change of an Event Topic

Receiving an event Topic control message, and when it is notified to create a new event Topic, a Publish message including an event corresponding to an event Topic and a rule included in the message is intercepted after the reception of the message, and an event Topic of the event is changed to the new event Topic.

Further, the final destination of the Publish message is changed to a rendezvous node in charge of the new event Topic, and the Publish message is transmitted to a broker node directly connecting with its own node. Further, instruction is issued to the Advertise sending unit 201 to send an Advertise message including the new event Topic while setting a rendezvous node in charge of the new event Topic as the final destination.

When it is notified to delete an existing event Topic, the following processing is performed. When an event Topic to be deleted is an event Topic added by the event Topic control message in the past, i.e., when an event Topic control message notifying about newly creation of an event to be deleted has been received, change of an event topic to the event Topic to be deleted is stopped.

When the event Topic control message received designates a merge destination event Topic, the event that is changed to the event Topic to be deleted is changed to a merge destination event Topic. Herein, when any merge destination event Topic is not designated, the event is sent with an event Topic that is originally set for its own node. When the event Topic to be deleted is not an event Topic added by the event Topic control message in the past (i.e., in the case of an event Topic originally set at its own node), an event corresponding to the event Topic to be deleted is changed to a merge destination event Topic.

The aforementioned function of a Publisher may be implemented by executing a program on a program control processor such as a CPU.

3. Configuration of a Subscriber

FIG. 10 is a block diagram schematically illustrating a functional configuration of a Subscriber in the present exemplary embodiment. A Subscriber SUB includes a Subscribe sending unit 301, an event Topic control message reception unit 302, and a Publish reception unit 303.

The Subscribe sending unit 301 includes an event Topic in a Subscribe message and sends the Subscribe message to a broker node directly connecting with its own node while setting a rendezvous node in charge of the event Topic as a final destination.

The event Topic control message reception unit 302 receives an event Topic control message from a broker node, changes and transmits an event Topic of a Publish message that the Publish reception unit 303 receives, and instructs the Subscribe sending unit 301 to send a Subscribe message.

The Publish reception unit 303 receives a Publish message, extracts an event from the received message and passes the event to an application (not illustrated).

### Change of an Event Topic

When the received event Topic control message indicates to create a new event Topic, the event Topic control message reception unit 302 intercepts a Publish message including an event corresponding to an event rule included in the message after the reception of the message, and changes an event Topic of the event to a new event Topic. The event Topic control message reception unit 302 further instructs the Subscribe sending unit 301 to send a Subscribe message including the new event Topic while setting a rendezvous node in charge of the new event Topic as a final destination.

When it is notified to delete an existing event Topic, the following processing is performed. When an event Topic to be deleted is an event Topic added by the event Topic control message in the past, i.e., when an event Topic control message notifying about newly creation of an event to be deleted has been received, change of an event topic to the event Topic to be deleted is stopped.

When the event Topic control message received designates a merge destination event Topic, the event that is changed to the event Topic to be deleted is changed to a merge destination event Topic. Herein, when any merge destination event Topic is not designated, the event is sent with an event Topic that is originally set for its own node. When the event Topic to be deleted is not an event Topic added by the event Topic control message in the past (i.e., in the case of an event Topic originally set at its own node), an event corresponding to the event Topic to be deleted is changed to a merge destination event Topic.

The aforementioned function of a Subscriber may be implemented by executing a program on a program control processor such as a CPU.

4. Event Topic Control Operation

The following describes an operation of a distributed event distribution system according to the present exemplary embodiment. Referring firstly to examples of FIGS. 11 to 14, an operation to newly create an event Topic is described below.

4.1) Creation of a New Event Topic

### Detection of Transmission Load Fluctuation Pattern

As described above, a broker node EB is provided with the transmission load fluctuation notification policy management table 106, where an event rule and a transmission load fluctuation pattern (i.e., notification policy) are set beforehand. When the event monitoring unit 105 refers to the transmission load fluctuation notification policy management table 106 to detect that transmission load of an event for a predetermined event rule matches with a transmission load fluctuation pattern (or estimates matching), the event monitoring unit 105 notifies the event Topic control unit 107 of the event rule and the transmission load fluctuation pattern.

### Selection of a Rendezvous Node

Receiving a load fluctuation notification from the event monitoring unit 105, the event Topic control unit 107 newly creates an event Topic corresponding to the advertised event rule and selects a rendezvous node from broker nodes. The following exemplifies a distributed event distribution system illustrated in FIG. 11.

FIG. 11 is a network diagram illustrating creation procedure of a new event Topic in a distributed event distribution system according to the present exemplary embodiment. Herein, let that a broker node EB_{F} is selected as a rendezvous node in charge of the event Topic “Weather in Kanto”. Further let that the transmission load fluctuation notification policy management table 106 of the broker node EB_{F} sets the content illustrated in FIG. 7 as a notification policy.

For instance, when the broker node EB_{F} measures that transmission frequency of an event matching with the event Topic “Weather in Kanto” and the Filtering rule “/Kanagawa/Yokohama” is 6,000 events/sec, it hits the entry of ID=1 in FIG. 7, and a notification of the content included at ID=1 is made to the event Topic control unit 107. The event Topic control unit 107 searches the event Topic control policy management table 108 using the advertised content. When the control policy illustrated in FIG. 8 is registered in the event Topic control policy management table 108, since the notification in this example matches with the entry of ID=1, the event Topic control unit 107 newly creates an event Topic, and selects a rendezvous node. In the example of FIG. 11, “Weather in Yokohama” is created as a new event Topic, and a broker node EB₃ is selected as a rendezvous node in charge of the event Topic.

### Sending of an Event Topic Control Message

Next, the event Topic control unit 107 of the broker node EB_{F} creates an event Topic control message and refers to an Advertisement table and a Subscription table to send the event Topic control message to a Next hop corresponding to an event rule advertised from the event monitoring unit 105.

FIG. 12 is a network diagram describing transmission procedure of an event Topic control message in a distributed event distribution system according the present exemplary embodiment. Note here that FIG. 12 illustrates the operation after the operation of the distributed event distribution system illustrated in FIG. 11 is finished.

Firstly, the broker node EB_{F} creates an event Topic control message indicated as “ETC” in FIG. 12, and refers to its own Advertisement table AT_{F} and Subscription table ST_{F} to send the event Topic control message ETC. In this case, an entry of ID=1 in the Advertisement table AT_{F} hits, the event Topic control message is transmitted to a broker node EB_{A} as its Next hop. At an entry of ID=2, there is no overlapping range between the Filtering rule included in the event Topic control message and the Filtering rule registered at the entry, and therefore the event Topic control message is not transmitted to the broker node EB_{B}. As for the Subscription table ST_{F}, the event Topic control message ETC is transmitted to the broker node EB_{C}.

The broker nodes EB_{A} and EB_{C} refer to their Advertisement tables and Subscription tables to transmit the received event Topic control messages ETC. Herein, when the Next hop is the same as a next preceding transmit source of the event Topic control message (for instance, an event Topic control message is not transmitted from the broker nodes EB_{C} and EB_{A} to EB_{F}), transmission is not performed. Similarly, the event Topic control message ETC is repeatedly transmitted by referring to an Advertisement table and a Subscription table of each broker node, and finally the event Topic control message ETC is distributed to all Publishers and Subscribers (in this case, PUB_{X} and SUB_{Z}) sending and receiving events using the newly created event Topic.

### Configuration of an Event Distribution Path

FIG. 13 is a network diagram describing configuration procedure of an event distribution path in a distributed event distribution system according the present exemplary embodiment. Note here that FIG. 13 illustrates the operation after the operation of the distributed event distribution system illustrated in FIG. 12 is finished.

Receiving the event Topic control message ETC, the Publisher PUB_{X} and the Subscriber SUB_{Z} send an Advertise message and a Subscribe message including the new event Topic therein to a broker node directly connected therewith while setting a rendezvous node EB₃ advertised by the event Topic control message ETC as a final destination. Thereby, an event distribution for the new event Topic can be configured.

Receiving the event Topic control message ETC, the Publisher PUB_{X} sends an Advertise message including a new event Topic “Weather in Yokohama” therein while setting a new rendezvous node EB₃ included in the event Topic control message ETC as a final destination. This message undergoes transmit processing at the broker nodes EB₁ and EB₂ (similarly to the transmission of a normal Advertise message, an entry of an Advertisement table is created), and reaches the new rendezvous node EB₃. Similarly, receiving the event Topic control message ETC, the Subscriber SUB_{Z} also sends a Subscribe message including a new event Topic “Weather in Yokohama” therein while setting a new rendezvous node EB₃ included in the event Topic control message ETC as a final destination. Similarly to the transmission of a normal Subscribe message as stated above, entries are newly created on the Subscription tables of the broker nodes EB₄, EB₃, EB₂ and EB₁.

In this way, an event distribution path is configured connecting the Publisher PUB_{X} and the Subscriber SUB_{Z} transmitting and receiving events using the new event Topic.

### Transmission of an Event Using a New Event Topic

FIG. 14 is a network diagram describing event transmission procedure in a distributed event distribution system according the present exemplary embodiment. Note here that FIG. 14 illustrates the operation after the operation of the distributed event distribution system illustrated in FIG. 13 is finished.

After finishing the configuration of an event distribution path, an event can be transmitted using newly created event Topics. When a Publish message including an event matching with the event rule advertised by the event Topic control message is sent from the Publish sending unit 203, the event Topic control message reception unit 204 of the Publisher PUB_{X} intercepts the Publish message and changes the event Topic of the event into the new event Topic. Thereby, the Publish message will be transmitted to the Subscriber SUB_{Z} using the new event Topic. That is, transmission is performed using an event distribution path corresponding to the new event Topic created by the aforementioned steps. Since an event is transmitted using the new event Topic via the rendezvous node EB₃ in charge of the new event Topic, load can be distributed among rendezvous nodes. The event Topic control message reception unit 302 of the Subscriber SUB_{Z} uses the new event Topic to change the event Topic of the received event and passes the same to the Publish reception unit 303.

The Publisher PUB_{X} changes the event Topic of the event matching with /Kanagawa/Yokohama into “Weather in Yokohama” for sending. This event is transmitted to the Subscriber SUB_{Z} via the new rendezvous node EB₃ along the event distribution path configured by the operation illustrated in FIG. 13.

4.2) Deletion of an Event Topic

FIG. 15 is a network diagram describing deletion procedure of an event Topic in a distributed event distribution system according the present exemplary embodiment. Note here that FIG. 15 illustrates the operation after the operation of the distributed event distribution system illustrated in FIG. 14 is finished.

Similarly to the creation of an event Topic, at the time of deletion of an event Topic, when the event monitoring unit 105 detects that transmission load of an event for a predetermined event rule matches with a transmission load fluctuation pattern or estimates the matching, the event monitoring unit 105 notifies the event Topic control unit 107 of the event rule and the transmission load fluctuation pattern. Receiving a notification from the event monitoring unit 105, the event Topic control unit 107 selects a target event Topic of the advertised event rule as an event Topic to be deleted, and selects a merge destination event Topic and a rendezvous node.

Next, the event Topic control unit 107 creates an event Topic control message ETC and refers to an Advertisement table and a Subscription table to send the event Topic control message ETC to a Next hop matching with the event rule advertised from the event monitoring unit 105. A broker node transmitting the event Topic control message ETC deletes an entry matching with the event Topic to be deleted included in the event Topic control message. Thereby, the event distribution path used for the event transmission of the event Topic to be deleted can be deleted.

In FIG. 15, the broker node EB₃ detects or estimates that fluctuations in transmission load of the event of the event Topic “Weather in Yokohama” match with the transmission load fluctuations pattern corresponding to the deletion of the event Topic, the broker node EB₃ creates an event Topic control message ETC illustrated in FIG. 15 and sends the message to a Next hop of the entry having the event Topic “Weather in Yokohama” registered in the Advertisement table and the Subscription table.

The event Topic control message ETC is transmitted successively by a broker node receiving the message to a Next hop of an entry having the event Topic “Weather in Yokohama” registered in its Advertisement table and the Subscription Table, and is finally distributed to the Publisher PUB_{X} and the Subscriber SUB_{Z} transmitting and receiving an event using the event Topic “Weather in Yokohama”. After transmission of the event Topic control message, each of the broker nodes EB₁ to EB₄ performing such transmission deletes an entry having the event Topic “Weather in Yokohama” from the Advertisement table and the Subscription table. Thereby, the event distribution path used for the transmission of an event of the event Topic “Weather in Yokohama” is deleted.

4.3) Effects

According to Exemplary embodiment 1 of the present invention, the following effects can be obtained.

a) The present exemplary embodiment can deal with fluctuations in the load of event transmission flexibly. This is because, in a distributed event system according to the present exemplary embodiment, an event distribution path can be dynamically newly created or deleted in accordance with fluctuations in the load of event transmission.

When the load in event transmission is increased or such an increase is expected, a broker node according to the present exemplary embodiment creates an event Topic newly, and selects a rendezvous node in charge of the new event Topic and instructs a Publisher and a Subscriber to newly create an event distribution path. Receiving the instruction, the Publisher and the Subscriber send an Advertise message and a Subscribe message to the newly selected rendezvous node, whereby an event distribution path can be newly created.

The Publisher and the Subscriber further transmit and receive a part or all of events using the new event distribution path. This operation allows the distributed event distribution system of the present invention to distribute the load on the existing event distribution path to the newly created event distribution path when the load in event transmission is increased or such an increase is expected.

When the load in event transmission is decreased or such a decrease is expected, a broker node according to the present exemplary embodiment deletes an existing event Topic, and selects a merge destination event Topic to be used for transmission and reception of an event after the deletion among existing event Topics and instructs a Publisher and a Subscriber to delete an event distribution path corresponding to the deleted event Topic. Receiving the instruction, the Publisher and the Subscriber transmit an Advertise message and a Subscribe message, whereby the event distribution path is deleted. This operation allows the distributed event distribution system of the present invention to delete an existing event distribution path to reduce overhead involved in keeping of the event distribution path when the load in event transmission is decreased or such a decrease is expected.

After the deletion of the event distribution path, the Publisher and the Subscriber transmit and receive an event that has been transmitted and received using the deleted event Topic using the merge destination event Topic. Thereby, an event can be transmitted and received even after the deletion of the event distribution path.

b) Among the events transmitted and received using the same event Topic, only events where the transmission load is increased or such an increase is expected can be transmitted and received using another event distribution path. This is because a broker node according to the present exemplary embodiment includes an event rule set therein, to which an event Topic as well as a Filtering rule and attributes of a Publish message can be added as conditions, and an event monitoring unit of the broker node monitors transmission load for each event rule.

A broker node creates a new event Topic corresponding to an event rule where the transmission load is increased or such an increase is expected, and selects a new rendezvous node. Then, the broker node notifies a Publisher and a Subscriber of such new event Topic and new rendezvous node as well as event rule and instructs the Publisher and the Subscriber to create a new event distribution path. Receiving the instruction, the Subscriber and the Publisher create a new event distribution path and thereafter transmit and receive an event matching with the event rule advertised using the new event distribution path. Thereby, among the events transmitted and received using the same event Topic, only events where the transmission load is increased or such an increase is expected can be transmitted and received using another event distribution path.

As compared with a simple load distributing method, i.e., a method of preparing a plurality of event distribution paths used for transmission and reception of events of the same event Topic and selecting these distribution paths for load distribution by a method such as a round-robin method, the method of the present exemplary embodiment is efficient.

For instance, the following considers an event distribution path used for transmission and reception of an event of the event Topic “A”. In the case of a simple load distributing method, all Subscribers and Publishers transmitting and receiving events “A” have to connect with all of the plurality of event distribution paths. That is, all of the Subscribers and the Publishers transmitting and receiving “A” have to send a Subscribe message and an Advertise message to a plurality of rendezvous nodes.

On the other hand, according to the present exemplary embodiment, among Subscribers and Publishers transmitting and receiving events “A”, only Subscribers and Publishers transmitting and receiving an event corresponding to an event rule where the transmission load is especially increased or such an increase is expected connect with an event distribution path newly created. Therefore, in the case of load distribution using a plurality of event distribute paths prepared, the present exemplary embodiment can reduce overhead involved in transmission of Subscribe and Advertise messages as compared with a simple load distribution method.

c) A broker node is allowed to newly create or delete an event distribution path without understanding individual Publishers and Subscribers. This is because a broker node sends and transmits an event Topic control message by referring to its Advertisement table and Subscription table. The Advertisement table and the Subscription table register a Next hop of a path to a Publisher and a Subscriber transmitting and receiving an event matching with an event Topic and a Filtering rule for each event Topic and each Filtering rule. Therefore, the broker node transmits an event Topic control message to the Next hop of the Advertisement table and the Subscription table matching with the event rule of the event Topic control message, whereby the event Topic control message can be distributed to the Publisher and the Subscriber without the necessity of understanding individual Publishers and Subscribers.

When an extremely large number (e.g., in the order of 10 million) of Publishers and Subscribers are present or when connection and disconnection are frequently performed from a Publisher and a Subscriber to an event distribution path, it doesn't appear viable that a broker node always understands IP addresses of individual Publishers and Subscribers and their participation states to an event distribution path. On the other hand, a broker node according to the present exemplary embodiment can deal with such a case.

d) At the time of deletion of an event distribution path, entries in the Advertisement and Subscription tables can be deleted promptly. This is because a broker node can delete an entry including an event Topic to be deleted from the Advertisement table and the Subscription table at the timing of reception of an event Topic control message as a trigger that advertises deletion of an event Topic without waiting of the sending from a Publisher and a Subscriber of an Advertise message and a Subscribe message including that an event of the event Topic to be deleted is no longer transmitted and received.

### 5. Exemplary Embodiment 2

Exemplary Embodiment 2 of the present invention has basically the same configuration as that of the aforementioned Exemplary Embodiment 1. Exemplary Embodiment 2, however, is different from Exemplary Embodiment 1 in that a reaching range of an event Topic control message can be limited to the vicinity of a broker node creating a new event Topic. Referring firstly to FIGS. 16 to 18, this difference is described below.

FIG. 16 is a network diagram illustrating an event distribution path of the event Topic “Weather in Kanto”. As described above, an event distribution path 401 is configured from a rendezvous node in charge of “Weather in Kanto” to a plurality of Publishers and Subscribers.

FIG. 17 is a network diagram illustrating an event distribution path of the event Topic “Weather in Yokohama” in Exemplary Embodiment 1 of the present invention. According to Exemplary Embodiment 1, when the rendezvous node in charge of the event Topic “Weather in Kanto” newly creates the event Topic “Weather in Yokohama”, an event Topic control message reaching range 403 leads to an end of the event distribution path, i.e., to all Publishers and Subscribers. In other words, an event distribution path for the new event Topic “Weather in Yokohama” is newly configured from the end.

FIG. 18 is a network diagram illustrating an event distribution path of the event Topic “Weather in Yokohama” in Exemplary Embodiment 2 of the present invention. Unlike the aforementioned Exemplary Embodiment 1, a reaching range 501 of an event Topic control message is limited to the vicinity of the rendezvous node in charge of the event Topic “Weather in Kanto”. That is, the event distribution path of the event Topic “Weather in Yokohama” uses a path common to the event Topic “Weather in Kanto” near the end of Publishers and Subscribers, and uses different paths only in the vicinity of the rendezvous node in charge of the event Topic “Weather in Kanto”.

In this way, in Exemplary Embodiment 2, a reaching range of an event Topic control message is limited to the vicinity of a broker node creating a new event Topic. This configuration can lead to the following effects.

(1) Since there is no need to wait for an event Topic control method reaching the end, an event distribution path can be configured promptly at the time of newly creation of an event Topic.

(2) Overhead involved in the transmission of an event Topic control message can be suppressed. Since an event Topic control message is not transmitted near the end, consumption of band-width in the network and calculation resource consumption at a broker node involved in the transmission of an event Topic control message near the end can be suppressed.

(3) The size of the Advertisement table and the Subscription table at a broker node can be suppressed. Since no entries are added to the Advertisement table and the Subscription table at a broker node near the end involved in the newly event Topic creation, their table size can be suppressed, whereby a decrease in table searching time can be expected.

The following describes an event Topic control system according to Exemplary Embodiment 2 of the present invention in detail.

5.1) Configuration and Operation of a Broker Node

FIG. 19 is a block diagram illustrating a functional configuration of a broker node including an event Topic control unit according to Exemplary Embodiment 2 of the present invention, and FIG. 20 illustrates an exemplary control policy set in an event Topic control policy management table. The same reference numerals are assigned to blocks having the same functions as in the broker node in Exemplary Embodiment 1 of FIG. 5 and descriptions thereon have been omitted.

In FIG. 19, a broker node EB is configured to have functions as a Subscription table 101, an Advertisement Table 102, a routing table management unit 103 and an event transmitting unit 104, and further as an event monitoring unit 105 and a transmission load fluctuation notification policy management table 106 as well as an event Topic control unit 601, an event Topic control policy management table 602, an event Topic control message reception unit 603, a Subscribe sending unit 604 and an Advertise sending unit 605. As described later, the event Topic control unit 601 is configured to have a function as a TTL control unit 601a to set/change a reaching range of an event Topic control message.

The broker node EB of the present exemplary embodiment is different from the broker node EB in Exemplary Embodiment 1 of FIG. 5 in that the event Topic control unit 601 and the event Topic control policy management table 602 have different functions and in that the event Topic control message reception unit 603, the Subscribe sending unit 604 and the Advertise sending unit 605 are further included. The following describes these differences in detail.

### Event Topic Control Unit

The event Topic control unit 601 in FIG. 19 includes the TTL control unit 601a as a reaching range control function to freely control a reaching range of an event Topic control message. A reaching range of an event Topic control message is controlled freely as follows. For instance, a node creating an event Topic control message sets a TTL (Time To Live) value. When an event Topic control message received from another broker node is transmitted, the TTL value is decreased by one. Then, unless the TTL value is zero, the message is transmitted, and when the TTL value becomes zero, the event Topic control message is received and not transmitted.

As illustrated in FIG. 20, a control policy set in the event Topic control unit 601 is an expansion of the control policy of Exemplary Embodiment 1 illustrated in FIG. 8. That is, a TTL value set for an event Topic control message is set as a part of the operation corresponding to an event rule and a transmission load fluctuation pattern. A reaching range is controlled on the basis of a policy such that a wider range of new event distribution path is configured with an increase in the load of its own node. For instance, for the same event rule, when the transmission frequency is 5,000 events/sec or more, TTL=5 is set, and when the transmission frequency is 10,000 events/sec or more, TTL=7 is set.

Further, calculation of TTL also can be changed flexibly in accordance with its own load when an event Topic control message received from another node is transmitted. Although the TTL is basically reduced by one for transmission, the TTL may be reduced by five when its own load is extremely low so that a range of transmission an event Topic control message (i.e., a configuration range of a new event distribution path) is limited to the vicinity thereof. Conversely, when its own load is large, the transmission range can be expanded by increasing the TTL by one. In this way, a TTL calculation method for the transmission of an event Topic control message is changed in accordance with the load of a broker node, whereby a configuration range of an event distribution path can be controlled so as to reflect the load status of a location away from a broker node creating a new event Topic.

The event Topic control unit 601 in the present exemplary embodiment decrement the TTL by one when an event Topic control message received from another broker node is transmitted. When the TTL value becomes zero, the event Topic control unit 601 instructs the event Topic control message reception unit 603 to perform reception processing of the event Topic control message.

### Event Topic Control Message Reception Unit

Receiving an instruction from the event Topic control unit 601, the event Topic control message reception unit 603 performs reception processing in a similar manner to the event Topic control message reception units (204, 302) of a Publisher and a Subscriber in Exemplary Embodiment 1 illustrated in FIG. 9 and FIG. 10. More specifically the following processing is performed.

1) When an adjacent broker node refers to its Advertisement table and transmits an event Topic control message to its own node, the event Topic control message reception unit 603 performs processing in a similar manner to the event Topic control message reception unit 204 of a Publisher in Exemplary Embodiment 1. That is, the event Topic control message reception unit 603 instructs the Advertise sending unit 605 to send an Advertise message including a new event Topic advertised by the event Topic control message while setting a new rendezvous node advertised by the same event Topic control message as a final destination.

When its own node transmits a Publish message, the event Topic control message reception unit 603 refers to an event rule included in the event Topic control message and intercepts a Publish message including an event matching with the event rule. Then, the event Topic control message reception unit 603 changes an event Topic of the Publish message into the new event Topic advertised by the event Topic control message. In this way, the event is distributed using the new event Topic. That is, the event is distributed using a new event distribution path created during the creation of the new event Topic.

2) When an adjacent broker node refers to its Subscription table and transmits an event Topic control message to its own node, the event Topic control message reception unit 603 performs processing in a similar manner to the event Topic control message reception unit 302 of a Subscriber in Exemplary Embodiment 1. That is, the event Topic control message reception unit 603 instructs the Subscribe sending unit 604 to send a Subscribe message including a new event Topic advertised by the event Topic control message while setting a new rendezvous node advertised by the same event Topic control message as a final destination.

The event Topic control message reception unit 603 further refers to a new event Topic included in the received event Topic control message and intercepts a Publish message including an event of the new event Topic. Then, the event Topic control message reception unit 603 changes an event Topic of the Publish message into a target event Topic included in the event rule. After changing, the event is distributed using the target event Topic. That is, the event is distributed using an event distribution path for distributing the event of the target event Topic that is present before the creation of the new event Topic.

### Subscribe Sending Unit

Receiving an instruction from the event Topic control message reception unit 603, the Subscribe sending unit 604 sends a Subscribe message including the new event Topic advertised by the event Topic control message while setting the new rendezvous node advertised by the same event Topic control message as a final destination.

### Advertise Sending Unit

Receiving an instruction from the event Topic control message reception unit 603, the Advertise sending unit 605 sends an Advertise message including the new event Topic advertised by the event Topic control message while setting the new rendezvous node advertised by the same event Topic control message as a final destination.

The aforementioned functions of the routing table management unit 103, the event transmitting unit 104, the event monitoring unit 105, the event Topic control unit 601, the event Topic control message reception unit 603, the Subscribe sending unit 604 and the Advertise sending unit 605 may be implemented by executing programs on a program control processor such as a CPU.

5.2) Effects

Exemplary Embodiment 2 of the present invention leads to the following effects in addition to the effects from Exemplary Embodiment 1 described before.

a) Overhead involved in the newly creation and deletion of an event distribution path can be suppressed. More specifically, the effect is as follows. A broker node transmitting an event Topic control message can freely control a reaching range of the message by setting a TTL in the event Topic control message. Further, when a TTL of an event Topic control message becomes 0 during transmission, a broker node, instead of a Subscriber and a Publisher, can transmit an Advertise message and a Subscribe message. Thereby, there is no need to transmit an event Topic control message to the end of an event distribution path (i.e., to the Publisher and the Subscriber), so that overhead involved in the newly creation and deletion of an event distribution path can be suppressed.

b) A range of newly creation of an event distribution path can be controlled in accordance with fluctuations in the load of event transmission. This is because a broker node transmitting or transmitting an event Topic control message is allowed to change a TTL value of the event Topic control message in accordance with fluctuations in the transmission load of an event. For instance, a larger TTL value is set for a larger increasing range of load detected, whereby the event Topic control message can reach a wide range and an event distribution path can be newly created in a wider range.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-24590, filed on Feb. 5, 2009, the disclosure of which is incorporated herein in its entirety by reference.

### INDUSTRIAL APPLICABILITY

The present invention is applicable to typical broker node-based distributed event distribution systems.

### REFERENCE SIGNS LIST

101 Subscription table
102 Advertisement Table
103 routing table management unit
104 event transmitting unit
105 event monitoring unit
106 transmission load fluctuation notification policy management table
107 event Topic control unit
108 event Topic control policy management table
201 Advertise sending unit
202 event generation unit
203 Publish sending unit
204 event Topic control message reception unit
301 Subscribe sending unit
302 event Topic control message reception unit
303 Publish reception unit
401 event distribution path
402 event Topic control message
403 event Topic control message reaching range
501 event Topic control message reaching range
601 event Topic control unit
602 event Topic control policy management table
603 event Topic control message reception unit
604 Subscribe sending unit
605 Advertise sending unit
PUB Publisher
SUB Subscriber
EB broker node (Event Broker)

1-37. (canceled)

38. A broker node for transmitting an event in a distributed event distribution system, comprising:
a monitoring unit that monitors fluctuations in transmission load of an event on the broker node for every event rule; and
a control unit that dynamically changes an event topic to transmit the event in accordance with the fluctuations in transmission load and notifies another node of an instruction of the change using a control message.

39. The broker node according to claim 38, wherein the control unit newly creates, deletes or moves an event topic.

40. The broker node according to claim 38, wherein the control unit includes a reaching range control unit to control a reaching range of the control message.

41. The broker node according to claim 40, wherein the reaching range control unit sets a TTL (Time To Live) value of the control message in accordance with the fluctuations in transmission load.

42. The broker node according to claim 41, wherein, when a control message from another broker node is transmitted, the reaching range control unit changes a TTL value in accordance with the fluctuations in transmission load.

43. The broker node according to claim 42, wherein, when a TTL value of a control message from another broker node becomes zero, the control unit does not transmit but receives the control message.

44. The broker node according to claim 38, wherein, when a new event topic is to be created, the control unit newly selects a rendezvous node in charge of the new event topic among other broker nodes and notifies another node of the new event topic and the rendezvous node for transmitting of the event using the control message.

45. The broker node according to claim 44, wherein, when transmission load of an event matching with a predetermined event rule matches with a predetermined increase pattern, the control unit creates a new event topic corresponding to the predetermined event rule, newly selects a rendezvous node in charge of the new event topic among other broker nodes and instructs, using the control message, another node to use the new event topic and an event path passing through the rendezvous node for transmitting of the event matching with the predetermined event rule.

46. The broker node according to claim 38, wherein, when an event topic is to be deleted, after the event topic is deleted, the control unit selects a merge destination event topic used for transmitting of the event from existing event topics, and notifies another node of the merge destination event topic for transmitting of the event using the control message.

47. The broker node according to claim 46, wherein, when transmission load of an event matching with a predetermined event rule matches with a predetermined decrease pattern, the control unit deletes an event topic corresponding to the predetermined event rule, selects a merge destination event topic used for transmitting of an event matching with the predetermined event rule after deleting the event topic, and instructs, using the control message, another node to use the merge destination event topic for transmitting of the event matching with the predetermined event rule.

48. The broker node according to claim 38, wherein, when an event topic is to be moved, after the event topic is deleted, the control unit newly creates a merge destination event topic used for transmitting of the event, newly selects a rendezvous node in charge of the merge destination event topic from other broker nodes, and notifies another node of the merge destination event topic and the rendezvous node for transmitting of the event using the control message.

49. The broker node according to claim 48, wherein, when transmission load of an event matching with a predetermined event rule matches with a predetermined fluctuation pattern, the control unit deletes an event topic corresponding to the predetermined event rule, newly creates a merge destination event topic used for transmitting of an event matching with the predetermined event rule after deleting the event topic, newly selects a rendezvous node in charge of the merge destination event topic among other broker nodes, and instructs, using the control message, another node to use the merge destination event topic and an event distribution path passing through the rendezvous node for transmitting of the event matching with the predetermined event rule.

50. The broker node according to claim 38, further comprising an Advertisement table and a Subscription table, wherein,
when the control message is to be sent, the control unit searches for an entry matching with the predetermined event rule from entries of the Advertisement table or the Subscription table, and sends the control message to a next hop registered in the entry, and
when a control message received from another node is to be transmitted, the control unit searches for an entry matching with the predetermined event rule indicated with the received control message from entries of the Advertisement table or the Subscription table, and transmits the received control message to a next hop registered in the entry.

51. The broker node according to claim 50, wherein the control unit deletes an entry matching with the predetermined event rule indicated with the control message from the Advertisement table or the Subscription table at a timing of sending of the control message from the broker node or of transmitting of the control message received from the other broker node as a trigger.

52. An event topic control method at a broker node for transmitting an event in a distributed event distribution system, comprising:
monitoring fluctuations in transmission load of an event on the broker node for every event rule;
dynamically changing an event topic to transmit the event in accordance with the fluctuations in transmission load; and
notifying another node of an instruction of the change using a control message.

53. The event topic control method according to claim 52, wherein the change includes newly creation, deletion or movement of an event topic.

54. The event topic control method according to claim 52, wherein a reaching range of the control message is further controlled.

55. The event topic control method according to claim 54, wherein the reaching range is controlled by setting a TTL (Time To Live) value of the control message in accordance with the fluctuations in transmission load.

56. The event topic control method according to claim 55, wherein, when a control message from another broker node is transmitted, the reaching range is controlled by changing a TTL value in accordance with the fluctuations in transmission load.

57. The event topic control method according to claim 56, wherein, when a TTL value of a control message from another broker node becomes zero, the control message is not transmitted but is received.

58. The event topic control method according to claim 52, wherein, when a new event topic is to be created, a rendezvous node in charge of the new event topic is newly selected among other broker nodes and another node is notified of the new event topic and the rendezvous node for transmitting of the event using the control message.

59. The event topic control method according to claim 52, wherein, when an event topic is to be deleted, after the event topic is deleted, a merge destination event topic used for transmitting of the event is selected from existing event topics, and another node is notified of the merge destination event topic for transmitting of the event using the control message.

60. The event topic control method according to claim 52, wherein, when an event topic is to be moved, after the event topic is deleted, a merge destination event topic used for transmitting of the event is newly created, a rendezvous node in charge of the merge destination event topic is newly selected from other broker nodes, and another node is notified of the merge destination event topic and the rendezvous node for transmitting of the event using the control message.

61. A Publisher node in a distributed event distribution system including a plurality of broker nodes, comprising:
an advertise sending unit that sends an Advertise message;
a publish sending unit that sends a Publish message; and
a control unit that, receiving a control message instructing to change an event topic from a broker node, controls to send an Advertise message including a new event topic or a merge destination event topic indicated with the control message while setting a rendezvous node indicated with the control message as a final destination, and send a Publish message in which a predetermined event topic indicated with the control message to use the new event topic or the merge destination event topic for event transmitting is changed into the new event topic or the merge destination event topic.

62. A Subscriber node in a distributed event distribution system including a plurality of broker nodes, comprising:
a subscribe sending unit that sends a Subscribe message;
a publish reception unit that receives a Publish message; and
a control unit that, receiving a control message instructing to change an event topic from a broker node, instructs to send a Subscribe message including a new event topic or a merge destination event topic indicated with the control message while setting a rendezvous node indicated with the control message as a final destination.

63. A distributed event distribution system, comprising:
a Publisher node that sends an Advertise message and a Publish message;
a Subscriber node that sends a Subscribe message and receives the Publish message; and
a plurality of broker nodes that transmit an event from the Publisher node to the Subscriber node, wherein
each broker node includes:
a monitoring unit that monitors fluctuations in transmission load of an event on the broker node for every event rule; and
a control unit that dynamically changes an event topic to transmit the event in accordance with the fluctuations in transmission load and notifies another node of an instruction of the change using a control message.

64. The distributed event distribution system according to claim 63, wherein the control unit of the broker node newly creates, deletes or moves an event topic.

65. The distributed event distribution system according to claim 63, wherein the control unit of the broker node includes a reaching range control unit that controls a reaching range of the control message.

66. The distributed event distribution system according to claim 65, wherein the reaching range control unit sets a TTL (Time To Live) value of the control message in accordance with the fluctuations in transmission load.

67. The distributed event distribution system according to claim 66, wherein, when a control message from another broker node is transmitted, the reaching range control unit changes a TTL value in accordance with the fluctuations in transmission load.

68. The distributed event distribution system according to claim 67, wherein, when a TTL value of a control message from another broker node becomes zero, the reaching range control unit does not transmit but receives the control message.

69. A program for causing a program control processor in a broker node for transmitting an event in a distributed event distribution system to function as an event topic control device: the program makes the processor
monitor fluctuations in transmission load of an event on the broker node for every event rule;
dynamically change an event topic to transmit the event in accordance with the fluctuations in transmission load; and
notify another node of an instruction of the change using a control message.

70. The program according to claim 69, wherein the program makes the processor create an event topic newly, delete the event topic or move the event topic as the change of the event topic.

71. The program according to claim 69, wherein the program makes the computer control a reaching range of the control message.

72. The program according to claim 71, wherein the program makes the processor control the reaching range by setting a TTL (Time To Live) value of the control message in accordance with the fluctuations in transmission load.

73. The program according to claim 72, wherein the program makes the processor to control the reaching range by changing a TTL value in accordance with the fluctuations in transmission load, when a control message from another broker node is transmitted.

74. The program according to claim 73, wherein the program makes the processor receive the control message instead of transmitting, when a TTL value of a control message from another broker node becomes zero.
